(19) United States
(12) Patent Application Publication
(10) Pub. No.: US 2026/0313580 A1
(43) Pub. Date: Oct. 8, 2026

(54) ENTITIES AND METHODS FOR ENABLING DUAL RADIO REGISTRATION FOR SINGLE USER EQUIPMENT SUBSCRIPTION IN MOBILE NETWORKS

(71) Applicant: HUAWEI TECHNOLOGIES CO., LTD., Shenzhen (CN)

(72) Inventors: Clarissa Marquezan, Munich (DE); Steven James Wenham, Cambridge (GB); Marco Spini, Boulogne Billancourt (FR); Riccardo Trivisonno, Munich (DE)

(73) Assignee: HUAWEI TECHNOLOGIES CO., LTD., Shenzhen (CN)

(21) Appl. No.: 19/629,768

(22) Filed: Mar. 26, 2026

Related U.S. Application Data
(63) Continuation of application No. PCT/EP2023/076672, filed on Sep. 27, 2023.

(51) Int. Cl. H04W 60/00; H04W 88/06

(52) U.S. Cl. CPC H04W 60/005; H04W 88/06

(57) ABSTRACT

Disclosed are methods and apparatuses for dual radio registration. A first control plane entity can obtain first Registration Information, wherein the first Registration Information is related to dual radio capability of the user equipment (UE). The dual radio capability of the UE indicates that the UE has a subscription for a mobile network capable of being associated with a first and a second access node of the same radio access technology type, wherein the first access node is related to the mobile network, and the second access node is related to another mobile network. The first control plane entity can determine, based on the first Registration Information, whether the UE is capable of using dual radio capability, and enable use of dual radio capability for the UE.

### CROSS-REFERENCE TO RELATED APPLICATIONS

This application is a continuation of International Application No. PCT/EP2023/076672, filed on Sep. 27, 2023, the disclosure of which is hereby incorporated by reference in its entirety.

### TECHNICAL FIELD

The present disclosure relates to wireless communications. More particularly, the present disclosure relates to entities and methods for enabling dual radio registration using the same radio access type in cellular mobile networks.

### BACKGROUND

In 5th Generation (5G) systems, there are mechanisms related to multiple registrations of a single User Equipment (UE). A first group of mechanisms is in 5G system architecture and described in 3rd Generation Partnership Project (3GPP) Technical Specification (TS) 23.501 for dual registration of the same UE with a single subscription (i.e., for a single Subscriber Identity Module (SIM) card, therefore a single identification of the user equipment) under the mechanisms of Access Technology Steering, Switching, Splitting (ATSSS) where the UE uses one access type that is 3GPP (e.g., a gNB or NR access node) and another access node that is a non-3GPP type of Radio Access Technology (RAT) (e.g., WIFI). It is possible that a UE is registered and being served with one Public Land Mobile Network (PLMN) over one access node of a given RAT type and with another PLMN with another access node of a different RAT type.

There is another group of technical solutions where dual registration would apply: Multi-Universal Subscriber Identity Module (M-USIM) as defined in 3GPP 5G Architecture in TS 23.501. This case defines the situation in which two SIM Cards (i.e., two subscriptions or two USIM) are used by the same UE, which allows the UE to be registered and served by two different access nodes, one with each USIM. This means that this UE has two different subscriptions, one for each SIM card, and consequently two different registrations. In this case, inherently there are 2 mobile network providers (i.e., PLMNs) involved in the registration process. Even if the PLMN is the same, the two registrations are treated separately, because they are related to different USIM or SIM cards.

### SUMMARY

It is an objective of the present disclosure to provide improved entities and methods for enabling dual radio registration using the same radio access type in cellular mobile networks.

The foregoing and other objectives are achieved by the subject matter of the independent claims. Further implementation forms are apparent from the dependent claims, the description and the figures.

According to a first aspect a first control plane entity related to user equipment (UE) registration management in a mobile network is provided. In some embodiments, the first control plane entity may be a Unified Data Management (UDM) entity of the mobile network. In some embodiments, the mobile network may be a Home Public Land Mobile Network (HPLMN) and the first control plane entity may be a Home UDM (H-UDM), entity of the HPLMN.

The first control plane entity according to the first aspect is configured to obtain first Registration Information, wherein the first Registration Information is related to dual radio capability of the UE, wherein the dual radio capability of the UE indicates that the UE has a subscription for the mobile network capable of being associated with a first and a second access node of the same Radio Access Technology (RAT), type and wherein the first access node is related to the mobile network and the second access node is related to another mobile network. In some embodiments, the other mobile network may be a Visiting PLMN (VPLMN). Moreover, the first control plane entity according to the first aspect is configured to determine, based on the first Registration Information, whether the UE is capable of using dual radio capability, and to enable, e.g. trigger and/or support the configuration and/or define the configuration for and/or manage and/or support and/or allow and/or restrict, the use of dual radio capability for the UE. The dual radio capability of the UE is herein also referred to as Dual New Radio (DNR) capability of the UE.

Thus, the first control plane entity supports a UE with a single subscription being registered by two radio access nodes of the same radio access technology (e.g., two gNBs), where each access node belongs to a different PLMN.

In some embodiments, the first control plane entity is configured to obtain the first Registration Information from a second control plane entity or the first Registration Information is a local configuration. Thus, the first control plane entity may efficiently obtain the first Registration Information. In some embodiments, the second control plane entity may be an Access and Mobility Management Function (AMF) entity of the mobile network, in particular a Home AMF (H-AMF) entity. Additionally, in an implementation form, the first registration information is equivalent to the DNR Registration Information described below.

In some embodiments, the first Registration Information is indicative of a request for using dual radio capability and/or support for dual radio capability. Thus, the first Registration Information may convey additional information.

In some embodiments, the first Registration Information comprises a dual radio registration type, wherein the dual radio registration type indicates a type of UE registration request, and/or the first Registration Information comprises dual radio Capability Information, wherein the dual radio Capability Information indicates one or more parameters and/or one or more configurations related to the dual radio capability of the UE. In some embodiments, the dual radio registration type is equivalent to the DNR Registration Type, and the dual radio Capability Information is herein also referred to as DNR Capability Information.

In some embodiments, the dual radio Capability Information comprises any of the following:
an indication that the UE has the dual radio capability;
one or more identifications of one or more other mobile networks, e.g. VPLMNs, visible and/or reachable by the UE;
access types of the one or more other mobile networks, e.g. VPLMNs, visible and/or reachable by the UE;
one or more radio parameters usable by the UE with the first and the second access node of the same RAT type.

In some embodiments, the first control plane entity is further configured to determine whether the UE is capable of using dual radio capability based on at least one of: dual radio Subscription Information and/or one or more local configurations related to dual radio capability for the UE and/or for the mobile network, wherein the dual radio Subscription Information indicates one or more supported and/or allowed and/or restricted parameters related to the dual radio capability for the UE. Thus, the first control plane entity may efficiently determine whether the UE is capable of using the dual radio capability.

The dual radio Subscription Information is herein also referred to as DNR Subscription Information.

In some embodiments, the first control plane entity is further configured to determine the one or more supported and/or allowed and/or restricted parameters related to the dual radio capability of the UE. Thus, the first control plane entity may efficiently obtain the one or more parameters related to the dual radio capability of the UE.

In some embodiments, the dual radio Subscription Information comprises one or more of the following:
an indication the UE is allowed to use and/or has the dual radio capability;
one or more identifications of one or more other mobile networks, e.g. VPLMNs, allowed to be used by the UE with dual radio capability;
one or more identifications of one or more other mobile networks, e.g. VPLMNs, restricted to be used by the UE with dual radio capability;
information about one or more regions, spatial areas and/or locations covered by the mobile network and/or the other mobile network, where the UE is allowed to use dual radio capability; information about one or more radio access types the UE is allowed to use with dual radio capability.

In some embodiments, the first control plane entity according to the first aspect is configured to obtain the dual radio Subscription Information from a local storage and/or to receive the dual radio Subscription Information from another control plane entity, in particular a Home Unified Data Repository (H-UDR) of the mobile network. Thus, the first control plane entity may efficiently obtain the dual radio Subscription Information.

In some embodiments, the first Registration Information further comprises one or more of the following:
an identification of the UE;
an identification of the mobile network, e.g. HPLMN;
an identification of the access node serving the UE in the mobile network;
information about a region and/or area and/or location of the mobile network, e.g. HPLMN, where the UE requested the registration for the mobile network, e.g. HPLMN.

In some embodiments, for enabling the use of dual radio capability for the UE the first control plane entity according to the first aspect is further configured to perform any one of the following operations:
store an indication that the UE has the dual radio capability;
store the one or more supported and/or allowed and/or restricted parameters related to the dual radio capability of the UE;
allow the second control plane entity from the mobile network to register as serving the UE with the first access node and allow another control plane entity from the other mobile network to register as serving the same UE with the second access node;
maintain an indication of the second control plane entity from the mobile network as serving the UE with the first access node when receiving a request from the other control plane entity of the other mobile network to register as serving the UE with the second access node; and/or
maintain an indication of the other control plane entity from the other mobile network as serving the UE with the second access node when receiving a request from the second control plane entity of the mobile network to register as serving the UE with the first access node.

In some embodiments, the first control plane entity according to the first aspect is configured to determine and/or generate dual radio Support Information associated with the UE based on at least one of the following: the first Registration Information, dual radio Subscription Information, and the one or more local configurations related to dual radio capability for the UE and/or for the mobile network, wherein the dual radio Support Information indicates at least one of: dual radio Capability Information that can be supported by and/or configured for the UE and/or dual radio Capability Information that is in use by the UE or that is associated with the UE in a given point in time, e.g. the dual radio Context Information. Thus, the first control plane entity may efficiently determine and/or generate the dual radio Support Information associated with the UE. The dual radio Support Information is herein also referred to as DNR Support Information and the dual radio Context Information is herein also referred to as DNR Context Information.

In some embodiments, the first control plane entity is further configured to provide to the second control plane entity of the mobile network any of the following: the dual radio Support Information; the dual radio Subscription Information; and/or dual radio Context Information, wherein the dual radio Context Information indicates information, such as one or more parameters, related to the dual radio capability in use by the UE or associated to the UE at a given point in time.

In some embodiments, the first control plane entity is configured to provide the dual radio Support Information associated with the UE and/or the dual radio Subscription Information and/or dual radio Context Information to the second control plane entity, in response to a request from the second control plane entity, wherein the request is related to UE registration.

In some embodiments, the request related to UE registration further comprise a request for any of the following: dual radio Support Information, dual radio Subscription Information, and/or dual radio Context Information.

In some embodiments, the dual radio Support Information comprises at least one of dual radio Subscription Information, and dual radio Context Information. In other words, in an implementation form, the dual radio Subscription Information and/or the dual radio Context Information may be part of the dual radio Support Information.

In some embodiments, the first control plane entity according to the first aspect is further configured to determine and/or generate the dual radio Context Information associated with the UE based on at least one of: the first Registration Information, and the dual radio Subscription Information, and the one or more local configurations related to dual radio capability for the UE and/or for the mobile network, wherein the dual radio Context Information associated with the UE indicates the information, e.g. one or more parameters, related to the dual radio capability in use by the UE or associated to the UE at a given point in time.

In some embodiments, the first control plane entity is further configured to provide the dual radio Context Information associated with the UE to the second control plane entity.

In some embodiments, the dual radio Context Information comprises one or more of the following: an identification of the UE, e.g. a SUPI; an identification of the other mobile network, e.g. a PLMIN ID of the VPLMN; an identification of the mobile network, e.g. a PLMN ID of the HPLMN; an identification of the first access node; an identification of the second access node; information about one or more regions, spatial areas and/or locations covered by the mobile network and/or the other mobile network, where the UE is allowed to use the dual radio capability.

In some embodiments, the first control plane entity is further configured to provide an indication of no dual radio support associated with the UE to the second control plane entity, wherein the indication of no dual radio support associated with the UE indicates at least one of: the UE has no dual radio capability; and/or the requested and/or indicated dual radio capability information associated with the UE comprised in the first Registration Information is restricted to the UE. As used herein, no dual radio support associated with the UE may have the same meaning as any one of the following: No DNR Support, DNR Capability rejection, UE registration rejection with a DNR rejection indication, DNR rejection indication.

In some embodiments, the first control plane entity is configured to receive the first Registration Information from the second control plane entity, e.g. the H-AMF entity, as a part of a request from the second control plane entity for registering the second control plane entity as serving Network Function (NF), for the UE in the mobile network.

In some embodiments, the first control plane entity is further configured to store an indication that the second control plane entity registered as serving NF for the UE in the mobile network is related to primary registration information (also referred to as primary registration) associated with the UE, wherein the primary registration information comprises one or more parameters related to the UE with dual radio capability for the mobile network.

In some embodiments, the first control plane entity is configured to receive another request from another control plane entity from another mobile network for registering the other control plane entity as serving NF for the UE in the other mobile network, wherein the first control plane entity is further configured to determine the other request to be related to the dual radio capability of the UE.

In some embodiments, the first control plane entity is further configured to store an indication that the other control plane entity registered as serving NF for the UE in the other mobile network is related to secondary registration information (also referred to as secondary registration) associated with the UE, wherein the secondary registration information comprises one or more parameters related to the UE with dual radio capability for the other mobile network.

In some embodiments, the first control plane entity is configured to reject the request from the second control plane entity for registering the second control plane entity as serving NF for the UE in the mobile network, if the UE is not capable of using and/or not allowed to use the dual radio capability.

In some embodiments, when the first control plane entity rejects the request, it may trigger the first control plane entity to provide to the second control plane entity an indication of no dual radio support associated with the UE to the second control plane entity. This indication may be comprised in a UE registration rejection message, for instance.

In some embodiments, the first control plane entity is further configured to update the dual radio Support Information and/or the dual radio Context Information, in response to a request for de-registering as serving NF for the UE associated with the dual radio Support Information from the second control plane entity of the mobile network and/or from the other control plane entity of the other mobile network.

In some embodiments, the first control plane entity is further configured to update the dual radio Support Information, in response to an obtained change in the dual radio Subscription Information.

As used herein, the enabling of the use of dual radio capability for the UE may also include the information the first control plane entity provides to the second control plane entity such as any of the following: dual radio Support Information, dual radio Context Information, primary registration information, secondary registration information, dual radio Subscription Information.

According to a second aspect a method of operating a first control plane entity, in particular an H-UDM entity, related to UE registration management in a mobile network is provided. The method according to the second aspect comprises the steps of:
obtaining first Registration Information, wherein the first Registration Information is related to dual radio capability of the UE, wherein the dual radio capability of the UE indicates that the UE has a subscription for the mobile network capable of being associated with a first and a second access node of the same RAT type and wherein the first access node is related to the mobile network and the second access node is related to another mobile network, e.g. VPLMN;
determining, based on the first Registration Information, whether the UE is capable of using dual radio capability; and
enabling, e.g. triggering and/or supporting and/or configuring and/or managing and/or defining the configuration for the use of dual radio capability for the UE.

The method according to the second aspect of the present disclosure can be performed by the first control plane entity according to the first aspect of the present disclosure. Thus, further features of the method according to the second aspect of the present disclosure result directly from the functionality of the first control plane entity according to the first aspect of the present disclosure as well as its different implementation forms described above and below.

According to a third aspect a second control plane entity for a mobile network is provided. In some embodiments, the second control plane entity may be an Access and Mobility Management Function, AMF, entity of the mobile network. In some embodiments, the mobile network may be a Home Public Land Mobile Network, HPLMN, and the second control plane entity may be a Home AMF, H-AMF, entity of the HPLMN.

The second control plane entity according to the third aspect is configured to provide first Registration Information to a first control plane entity, in particular a H-UDM entity, of the mobile network, wherein the first Registration Information is related to dual radio capability of a UE wherein the dual radio capability of the UE indicates that the UE has a subscription for the mobile network capable of being associated with a first and a second access node of the same RAT type and wherein the first access node is related to the mobile network and the second access node is related to another mobile network, e.g. a VPLMN. Moreover, the second control plane entity according to the third aspect is configured to obtain a dual radio registration indication (also referred as DNR Registration Indication) and/or configuration related to the dual radio capability of the UE, wherein the dual radio registration indication and/or configuration is indicative of a request for using dual radio capability and/or support for dual radio capability associated with the UE. The second control plane entity according to the third aspect is further configured to generate the first Registration Information based on the obtained information, i.e. based on the dual radio registration indication and/or configuration.

In some embodiments, the second control plane entity is configured to generate the first Registration Information, in response to receiving a request from the UE comprising the dual radio registration indication.

As used herein, a control plane entity receiving a request from the UE, implies that such a request first has been transmitted via a radio access node and then sent to the control plane entity. The message can be either exactly the same as the one sent by the UE or it can be further processed by the radio access node and then sent to the control plane entity. As a simplification, this is herein described as a control plane entity receiving a request from the UE. The same logic applies for information and/or messages that a control plane entity sends or provides to a UE. This information and/or message may first be transmitted to a radio access node and then further transmitted (either exactly as sent by the control plane entity, or further processed by the radio access node) to the UE.

In some embodiments, the second control plane entity is further configured to obtain from the first control plane entity any of the following:
dual radio Support Information and/or updated dual radio Support Information, wherein the dual radio Support Information indicates at least one of: dual radio Capability Information that can be supported by and/or configured for the UE and/or dual radio Capability Information that is in use by the UE or that is associated with the UE at a given point in time, e.g. the dual radio Context Information;
dual radio Subscription Information, wherein the dual radio Subscription Information indicates one or more supported and/or allowed and/or restricted parameters related to the dual radio capability for the UE;
dual radio Context Information related to the UE with dual radio capability, wherein the dual radio Context Information related to the UE indicates the information, e.g. one or more parameters, related to the dual radio capability in use by the UE or associated to the UE at a given point in time;
primary registration information associated with the UE, wherein the primary registration information comprises one or more parameters related to the UE with dual radio capability for the mobile network;
secondary registration information associated with the UE, wherein the secondary registration information comprises one or more parameters related to the UE with dual radio capability for the other mobile network.

In some embodiments, the second control plane entity is further configured to provide dual radio information to the UE and/or updated dual radio information to the UE, wherein the dual radio information and/or the updated dual radio information is based on the information obtained from the first control plane entity, i.e. the dual radio registration indication and/or configuration related to the dual radio capability of the UE, and wherein the dual radio information indicates the one or more parameters related to the dual radio capability of the UE to be used by and/or associated with the UE.

According to a fourth aspect, a method for operating a second control plane entity, in particular a H-AMF entity, for a mobile network is provided. The method according to the fourth aspect comprises the steps of:
obtaining a dual radio registration indication and/or configuration related to the dual radio capability of a UE wherein the dual registration indication and/or configuration is indicative of a request for using dual radio capability and/or support for dual radio capability associated with the UE;
generating first Registration Information based on the obtained information, i.e. the dual radio registration indication and/or configuration related to the dual radio capability of the UE; and
sending the first Registration Information to a first control plane entity of the mobile network, wherein the first Registration Information is related to dual radio capability of the UE, wherein the dual radio capability of the UE indicates that the UE has a subscription for the mobile network capable of being associated with a first and a second access node of the same RAT type and wherein the first access node is related to the mobile network and the second access node is related to another mobile network.

The method according to the fourth aspect of the present disclosure can be performed by the second control plane entity according to the third aspect of the present disclosure. Thus, further features of the method according to the fourth aspect of the present disclosure result directly from the functionality of the second control plane entity according to the third aspect of the present disclosure as well as its different implementation forms described above and below.

According to a fifth aspect a UE for using dual radio capability in a mobile network is provided. The UE according to the fifth aspect is configured to provide a dual radio registration indication to a second control plane entity of the mobile network, wherein the dual radio registration indication is related to dual radio capability of the UE, wherein the dual radio capability of the UE indicates that the UE has a subscription for the mobile network capable of being associated with a first and a second access node of the same RAT type and wherein the first access node is related to the mobile network and the second access node is related to another mobile network. Moreover, the UE is configured to obtain from the second control plane entity of the mobile network dual radio information, wherein the dual radio information indicates one or more parameters related to the dual radio capability of the UE to be used by and/or associated with the UE.

In some embodiments, the dual radio registration indication comprises a dual radio registration type, wherein the dual radio registration type indicates a new type of UE registration request and/or dual radio Capability Information, wherein the dual radio Capability Information indicates one or more parameters and/or one or more configurations related to the dual radio capability of the UE.

In some embodiments, the UE is configured to obtain the dual radio Capability Information based on stored configuration information and/or monitored information.

In some embodiments, in response to providing via a message the dual radio registration indication to the second control plane entity, the UE is configured to receive from the second control plane entity a confirmation of the registration comprising the dual radio information.

In some embodiments, based on the obtained dual radio Information the UE is further configured to select the other mobile network for registering when using the dual radio capability.

In some embodiments, in response to providing the dual radio registration indication to the second control plane entity, the UE is configured to receive from the second control plane entity a registration rejection with a dual radio rejection indication related to the dual radio capability.

In some embodiments, the dual radio rejection indication comprises any of the following: dual radio capability is not being available or allowed for the UE; and/or one or more parameters comprised in the dual radio Registration Indication and/or information of the UE registration request are not supported and/or allowed for the UE.

According to a sixth aspect a method for operating a UE for using dual radio capability in a mobile network is provided. The method comprises the steps of:
sending a dual radio request and/or capability indication to a second control plane entity of the mobile network, wherein the dual radio request and/or capability indication is related to dual radio capability of the UE, wherein the dual radio capability of the UE indicates that the UE has a subscription for the mobile network capable of being associated with a first and a second access node of the same RAT type and wherein the first access node is related to the mobile network and the second access node is related to another mobile network; and
obtaining from the second control plane entity of the mobile network a dual radio information, wherein the dual radio information indicates the one or more parameters related to the dual radio capability of the UE to be used by and/or associated with the UE.

The method according to the sixth aspect of the present disclosure can be performed by the UE according to the fifth aspect of the present disclosure. Thus, further features of the method according to the sixth aspect of the present disclosure result directly from the functionality of the UE according to the fifth aspect of the present disclosure as well as its different implementation forms described above and below.

According to a seventh aspect, a computer program product is provided, comprising a computer-readable storage medium for storing a program code which causes a computer or a processor to perform the method according to the second aspect, the method according to the fourth aspect, or the method according to the sixth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a mobile telecommunication system comprising a User Equipment (UE) according to an embodiment with dual radio support by entities of a home Public Land Mobile Network (PLMN) and entities of a visiting PLMN;

FIGS. 2a-c show schematic diagrams illustrating different scenarios for dual radio support of a UE according to an embodiment by entities of a home PLMN and entities of a visiting PLMN;

FIG. 3 is a signalling diagram illustrating interactions between the UE, entities of a home PLMN, including a first and second control plane entity, as well as entities of a visiting PLMN according to an embodiment for providing dual radio support to the UE;

FIG. 4 is a signalling diagram illustrating interactions between the UE, entities of a home PLMN and entities of a visiting PLMN according to an embodiment for providing dual radio support to the UE for a first registration with the home PLMN;

FIG. 5 is a signalling diagram illustrating interactions between the UE, entities of a home PLMN and entities of a visiting PLMN according to another embodiment for providing dual radio support to the UE for a first registration with the home PLMN;

FIG. 6 is a signalling diagram illustrating interactions between the UE, entities of a home PLMN and entities of a visiting PLMN according to an embodiment for providing dual radio support to the UE for a first registration with the visiting PLMN;

FIG. 7 is a signalling diagram illustrating further details of the interactions between the UE, entities of a home PLMN and entities of a visiting PLMN according to the embodiment of FIG. 4 for providing dual radio support to the UE;

FIG. 8 is a signalling diagram illustrating further details of the interactions between the UE, entities of a home PLMN and entities of a visiting PLMN according to the embodiment of FIG. 4 for providing dual radio support to the UE;

FIG. 9 is a flow diagram illustrating a method for operating a first control plane entity according to an embodiment;

FIG. 10 is a flow diagram illustrating a method for operating a second control plane entity according to an embodiment; and

FIG. 11 is a flow diagram illustrating a method for operating a UE according to an embodiment.

In the following, identical reference numbers refer to identical or at least functionally equivalent features.

### DETAILED DESCRIPTION OF THE EMBODIMENTS

In the following description, reference is made to the accompanying figures, which form part of the disclosure, and which show, by way of illustration, aspects of embodiments of the present disclosure or aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. Moreover, if an apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless noted otherwise.

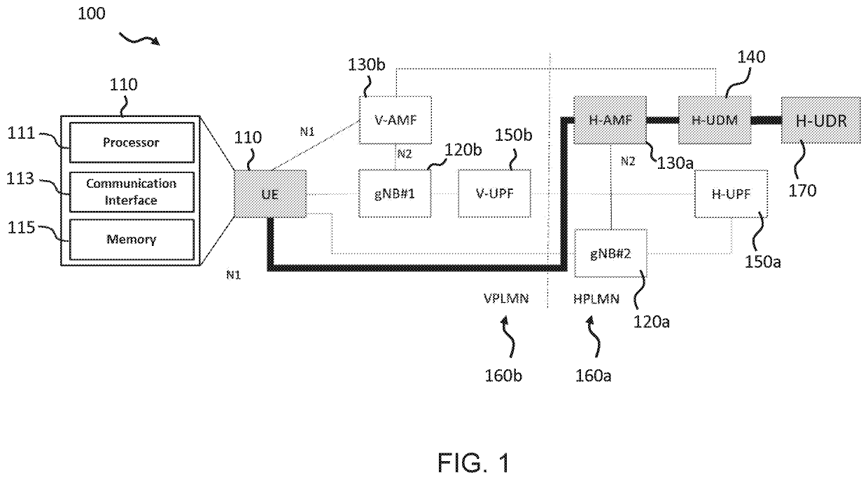

FIG. 1 shows a schematic diagram illustrating a mobile telecommunication system 100 comprising at least one user equipment (UE) 110 being provided with dual radio support of the same Radio Access Technology (RAT) type, for instance, the 5th Generation (5G) RAT, by a Home Public Land Mobile Network (HPLMN) 160a and a Visiting PLMN (VPLMN) 160b. In an embodiment, the mobile telecommunication system 100 is a 3rd Generation Partnership Project (3GPP) mobile telecommunication system 100.

The HPLMN 160a comprises or is associated with a plurality of first access nodes or base stations of the same RAT type, such as the first access node 120a, a Home Access and Mobility Management Function (H-AMF) 130a, a Home Unified Data Management (H-UDM) 140, a Home User Plane Function (H-UPF) 150a, and a Home Unified Data Repository (H-UDR) 170. The VPLMN 160b comprises or is associated with a plurality of second access nodes or base stations of the same RAT type as the first access node 120a of the HPLMN 160a, such as the second access node 120b, a visiting AMF (V-AMF) 130b, and a visiting UPF (V-UPF) 150b. As will be appreciated, the HPLMN 160a and the VPLMN 160b may comprise further entities in addition to the entities illustrated in FIG. 1 for operating as a HPLMN and a VPLMN, respectively. For instance, like the HPLMN 160a the VPLMN 160b may comprise a UDM and/or a UDR, which, however, are of less relevance for the embodiments disclosed herein.

As illustrated in FIG. 1, the UE 110 may comprise a processing circuitry, e.g. one or more processors 111 and a communication interface 113. The processing circuitry 111 may be implemented in hardware and/or software. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the UE 110 may comprise a memory 115 configured to store executable program code which, when executed by the processing circuitry 111, causes the UE 110 to perform the functions and operations described herein.

Likewise, the H-UDM 140 and the H-AMF 130a may be implemented in hardware and/or software, for instance, in the form of network functions of the HPLMN 160a. The hardware may comprise digital circuitry, or both analog and digital circuitry. Digital circuitry may comprise components such as ASICs, FPGAs, DSPs, or one or more general-purpose processors. Moreover, the H-UDM 140 and/or the H-AMF 130a may be configured to store or comprise executable program code which, when executed causes the H-UDM 140 and/or the H-AMF 130a to perform the functions and operations described herein.

Before describing more detailed embodiments of the first control plane entity 140, in particular H-UDM 140, the second control plane entity 130a, in particular H-AMF 130a, and the UE 110 for providing dual radio support to the UE 110, in the following some technical background as well as terminology will be introduced making use of one or more of the following abbreviations:

| | |
|---|---|
| 5th Generation | 5G |
| Control Plane | CP |
| Core Network | CN |
| Radio Access Technology | RAT |
| Access Traffic Steering, Switching, Splitting | ATSSS |
| Universal Subscriber Identity Module | USIM |
| Multi Universal Subscriber Identity Module | M-USIM/MUSIM |
| Subscriber Identity/Identification Module | SIM |
| Public Land Mobile Network | PLMN |
| Home Public Land Mobile Network | H-PLMN/HPLMN |
| Visiting Public Land Mobile Network | V-PLMN/VPLMN |
| User Equipment | UE |
| Network Function | NF |
| Unified Data Management | UDM |
| Access Management Function | AMF |
| New Radio | NR |
| Terrestrial Network | TN |
| Non-Terrestrial-Network | NTN |
| Satellite | SAT |
| Low Earth Orbit | LEO |
| Medium Earth Orbit | MEO |
| Geostationary Orbit | GEO |
| Other Satellite | OTHERSAT |
| Dual NR | DNR |
| Unified Data Repository | UDR |

The standard specification 3GPP TS 23.502 defines the procedures for the registration of a UE. In this procedure all the cases of registration in the H-PLMN or registration of UEs in roaming (at a V-PLMN) are considered, as well as registration using multiple RAT types for the same UE subscription information. In this registration process, one key step is the AMF serving the UE registering itself as the serving AMF for a given UE with a given subscription for a given access node of a given RAT type. In 5GS, the UDM Network Function (NF) controls the mapping among the AMF, the UE subscription information (e.g., identified by the UE SUPI identifier), the RAT Type, and the PLMN.

Following the standardized registration procedure as per TS 23.502 Clause 4.2.2.2.2 (registration procedure) when an AMF is registering at UDM as the serving AMF for a given UE with a given RAT Type, the UDM is able to detect if there is already another AMF registered as serving the UE for the same RAT Type. Once the UDM detects the existence of a previously registered AMF as serving NF for the UE with the same RAT type, the UDM will trigger the de-registration of the previous AMF in order to update the mapping of the new AMF serving the same UE with the same RAT type. Additionally, this de-registration process of the previous AMF will also trigger the release of all PDU sessions of the UE using the access node of the same RAT type.

Therefore, when a conventional UE registers in its HPLMN with a serving H-AMF for an access node of type NR and thereafter wants to perform the registration in the VPLMN with a serving V-AMF for an access node of type NR, a conventional UDM will trigger the de-registration of the H-AMF and will not allow the UE to use both NR node types from the HPLMN and the VPLMN, respectively. Thus, a conventional UDM allows the UE to use only one of the access nodes of NR type simultaneously.

As a consequence of a conventional UDM accepting only one AMF registered as serving the same UE (with a single subscription) for an access node of a given RAT Type, the following problems may arise:
UEs are prevented from simultaneously using two 3GPP NR nodes via different PLMNs, i.e. a HPLMN and a VPLMN, because any request from the UE for registering in the second NR node will always cause the UDM to trigger the Network-Triggered Deregistration of any previous AMF registered at the H-UDM (either a H-AMF if a UE is first registered at the H-PLMN, or the V-AMF if the UE first registered at the V-PLMN), as well as the PDU sessions release procedures for any PDU session that has been associated with an Access Context related to the previously registered AMF that is being then deregistered by the H-UDM (as per the standard specification TS 23.502 Clause 4.2.2.2.2).
The XR or metaverse application cannot actually use the capacity from the 2 mobile networks (PLMNs) even if the UE has a radio stack able to use two access nodes, e.g. gNBs.

Embodiments disclosed herein provide a control plane entity, in particular a H-UDM 140, configured to accept more than one AMF registered as serving a single UE with a single subscription for multiple access nodes from different mobile networks (PLMNs) with the same RAT Type. To this end, embodiments disclosed herein are based on enhancements and/or modifications for network entities according current 5GS Architecture for supporting the registration of the UE 110 with DNR Capability, thus, enabling the UE 110 to use two NR paths of the same RAT type. Embodiments disclosed herein focus on enhancing the HPLMN awareness for supporting the UE 110 with DNR capability without enforcing changes in the VPLMN 160b. This is because, any changes in interactions between VPLMN 160b and HPLMN 160a usually result in changes in the roaming interfaces and/or services and/or on roaming agreements, which leads to a non-neglectable cost for the mobile network operators. However, as the main purpose of embodiments disclosed herein is to enable in particular the H-UDM 140 to support multiple AMFs 130a,b serving the UE 110 with a single subscription and with two NR RAT Type access nodes 120a,b, the embodiments disclosed herein are focused on the H-AMF 130a, the H-UDM 140, and the UE 110, as well as their associated interfaces and services.

In some embodiments, a first control plane entity (H-UDM 140) is configured to obtain first Registration Information, wherein the first Registration Information is related to dual radio capability of the UE 110, the dual radio capability of the UE 110 indicates that the UE 110 has a subscription for the HPLMN capable of being associated with a first and a second access node 120a,b of the same RAT type and wherein the first access node 120a is related to, e.g. part of the HPLMN 160a and the second access node 120b is related to, e.g. part of the VPLMN 160b. The first control plane entity, in particular H-UDM 140 is further configured to determine, based on the first Registration Information, whether the UE 110 is capable of using dual radio capability, and to enable (e.g. trigger and/or support and/or manage and/or configure and/or allow and/or restrict and/or define) the configuration for the use of dual radio capability for the UE 110.

A second control plane entity, in particular the H-AMF 130a is configured to provide the first Registration Information to the first control plane entity, in particular the H-UDM 140 of the mobile network 160a. As already described above, the first Registration Information is related to dual radio capability of the UE 110, wherein the dual radio capability of the UE 110 indicates that the UE 110 has a subscription for the HPLMN 160a capable of being associated with a first and a second access node 120a,b of the same RAT type and wherein the first access node 120a is related to, e.g. part of the HPLMN 160a and the second access node 120b is related to, e.g. part of the VPLMN 160b. Moreover, the second control plane entity, in particular the H-AMF 130a is configured to obtain a dual radio registration indication and/or configuration related to the dual radio capability of the UE 110, wherein the dual radio registration indication and/or configuration is indicative of a request for using dual radio capability and/or support for dual radio capability associated with the UE 110. The second control plane entity, in particular H-AMF 130a is further configured to generate the first Registration Information based on the obtained information, i.e. based on the dual radio registration indication and/or configuration.

The UE 110 is configured to provide a dual radio registration indication to the second control plane entity, in particular the H-AMF 130a of the HPLMN 160a, wherein the dual radio registration indication is related to dual radio capability of the UE 110, the dual radio capability of the UE 110 indicates that the UE 110 has a subscription for the HPLMN 160a capable of being associated with a first and a second access node 120a,b of the same RAT type and wherein the first access node 120a is related to, e.g. part of the HPLMN 160a and the second access node 120b is related to, e.g. part of the VPLMN 160b. Moreover, the UE 110 is configured to obtain from the second control plane entity, in particular the H-AMF 130a of the HPLMN 160a dual radio information, wherein the dual radio information indicates one or more parameters related to the dual radio capability of the UE 110 to be used by and/or associated with the UE 110.

As used herein an access node (or base station) of NR RAT type, such as the first and the second access node 120a,b, is any access node that has the capability to exchange N2 and N1 messages with the UE 110 and/or Core Network. In other words, an access node of NR RAT Type is able to exchange the Access Network messages, such as registration request or PDU session request as defined in the procedures of 3GPP TS 23.502, e.g., registration procedure. Based on this definition, any of the following access nodes are to be considered as access nodes with the same NR RAT type: gNB access node, which means a terrestrial access node with NR RAT type; an NR satellite access node with NR(LEO) RAT Type; an NR satellite access node with NR(MEO) RAT Type; an NR satellite access node with NR(GEO) RAT Type; an NR satellite access node with NR(OTHERSAT) RAT Type.

As used herein, dual NR UE Capable (or UE 110 with dual NR capability) indicates information to allow the UE 110 to determine whether it has the DNR capability and/or whether the UE 110 should include in a registration request any information related to the DNR Capability.

As used herein, DNR Capability (or Capability to operate with DNR Support) is the support and/or definitions and/or information and/or processes related to the usage and/or enabling the usage and/or enabling the association of two access nodes 120a,b of same 3GPP RAT type (in particular NR RAT Type) related to a single UE 110, where the UE 110 has a single subscription information, and one of the access nodes 120a is related to the Home PLMN (i.e., the PLMN that is related to the UE subscription) 160a of the UE 110 and the other access node 120b of same NR RAT type is related to a VPLMN 160b (e.g., a mobile network operator that can serve the UE 110 but it not related to the UE subscription, e.g. did not provide the SIM Card associated with the UE subscription information).

As used herein, a DNR Registration Indication may contain information and/or parameters denoting that a registration process (or procedure or step or task) of a UE 110 is associated with a DNR Capability. For instance, the DNR Registration Indication can be understood as a request from the UE 110 to the network to activate (and/or use) the DNR Capability. Another example is the DNR Registration Indication being understood as the UE 110 informing the mobile network that it supports the DNR Capability.

As used herein, dual Registration means one registration at the H-AMF 130a with the UE subscription information at the HPLMN 160a with an access node 120a of NR RAT Type at the HPLMN 160a and another registration at the V-AMF 130b in the VPLMN 160b with the same UE subscription information from the HPLMN 160a and a different access node 120b from the VPLMN 160b but with the same NR RAT Type.

As used herein, DNR Capability Information indicates the one or more information elements and/or parameters and/or configurations related to the DNR Capability of a UE 110. The information (and/or parameters and/or configuration) is related to the UE subscription information with a mobile network (i.e., the HPLMN 160a).

As used herein, DNR Information indicates one or more information elements and/or parameters and/or configurations of the DNR Capability that can be used by (e.g., that is allowed to be used) and/or that is activated to the UE 110 and/or that are related to the dual registrations of the UE 110 (i.e., to the one or more registration information of the UE 110 for the same subscription information with the same RAT type of access nodes from different PLMNs). The DNR information enables the UE 110 to use and/or activate and/or deactivate the DNR Capability. It is possible that at a given point in time, only one registration information element is included or reflected or comprised in the DNR information (e.g., when the UE 110 first registers at one PLMN or when the UE 110 de-registers in one of the PLMNs related to the DNR Capability and/or Dual registration). For instance, this information related to what the UE 110 is allowed and/or can use with DNR Capability may have been determined (or defined or generated) by one or more core network entities (e.g., in accordance with the interactions among H-AMF 130a and H-UDM 140). The information related to the dual registrations of the UE 110 reflects or describes the information related to the entities and/or configurations and/or identifiers of the two registrations of the UE 110 in the different mobile networks.

As used herein, the DNR Registration Information indicates information and/or parameters (a) enabling the verification (or determination) whether DNR Capability is available and/or supported for the UE 110 and/or (b) triggering the activation (or configuration or usage) of the DNR Capability for the UE 110.

As used herein, DNR Subscription Information defines one or more information elements and/or parameters and/or configurations of the DNR Capability available (e.g., allowed and/or restricted) for the UE 110. The information (and/or parameters and/or configuration) may be related to Service Level Agreement (SLA) among operators and/or the UE subscription.

As used herein, DNR Context Information means one or more parameters (or information elements) defining the DNR Capability in use by the UE 110. The DNR Capability in use by the UE 110 may be further defined as the information (and/or parameters) associating (and/or mapping and/or relating) the UE 110 with the VPLMN 160b and/or the HPLMN 160a, and the VPLMN and/or HPLMN access node(s) 120a,b of NR RAT type, and one or more NFs (e.g., V-AMF 130b and/or H-AMF 130a) serving the UE 110 with the DNR Capability. For instance, the DNR subscription information may define a list of possible VPLMNs that the UE 110 is allowed to use with the DNR Capability, while the DNR Context Information comprises the information of which VPLMN and access nodes 120a,b of NR RAT Type in VPLMN 160b and HPLMN 160a, as well as AMF(s) are related to the UE 110 with DNR Capability.

As used herein, DNR Support Information means one or more information elements (or parameters) related to the available DNR Capability for the UE 110 and/or the DNR Capability in use by the UE 110. For instance, in one embodiment the DNR Support Information may comprise the information and/or parameters of the DNR Subscription Information and the information and/or parameters of the DNR Context Information. The DNR Support Information can support the H-UDM 140 as well as the H-AMF 130a to be aware of the available DNR Capabilities of the UE 110 as well as the DNR Capabilities in use by the UE 110.

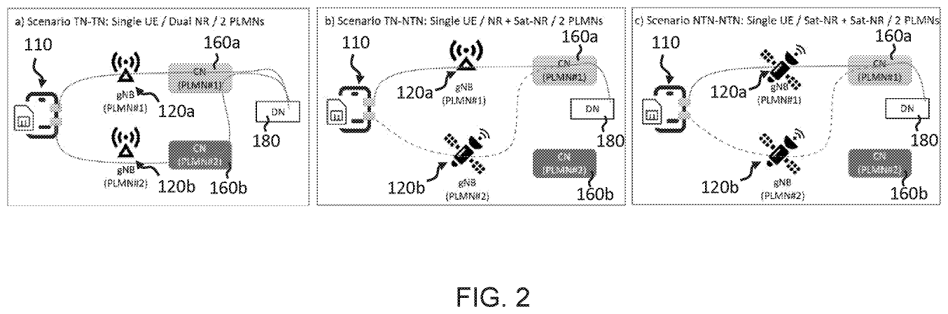

FIGS. 2a-c show schematic diagrams illustrating different scenarios for dual radio support of the UE 110 according to an embodiment by entities of the HPLMN 160a, in particular the H-UDM 140, the H-AMF 130a and the first access node 120a, and entities of the VPLMN 160b, in particular the V-AMF 130b and the second access node 120b, for providing connectivity to a data network 180. As already described above, the UE 110 has Dual NR capability (DNR Capability), i.e. the UE 110 is able to be associated with two access nodes 120a,b of the same NR technology. As used herein, the association may imply being registered with both networks, i.e., the HPLMN 160a and VPLMN 160b, related to the access nodes 120a,b (without necessarily being connected and/or using simultaneously the resources of the two access nodes 120a,b), and/or being connected and served by the two access nodes 120a,b (i.e., it is in RRC_CONNECTED state with the two gNBs 120a,b).

Another possible scenario is the UE 110 being associated to two eNBs RAT type, and/or one eNB and another gNB type of RAT. For all these scenarios the two access nodes 120a,b serving the UE 110 are 3GPP access nodes. In other words, they have a RAT type that is related to 3GPP definitions of radio access network.

As illustrated in FIGS. 2a-c, embodiments disclosed herein cover the scenario where two PLMNs 160a,b are involved in serving the UE 110 with DNR Capability, namely the HPLMN 160a and VPLMN 160b. The home PLMIN (or HPLMN or H-PLMN) 160a is the mobile network that is related to the UE subscription information (e.g., is the mobile operator that the UE 110 subscribed to, e.g., bought the SIM Card), while the visiting PLMIN (or VPLMN or V-PLMN) 160b is a mobile network that can provide the connectivity services for the UE 110 that does not have a subscription with this mobile network. As will be appreciated, this constitutes a roaming scenario. As already supported in 5GS Architecture defined by 3GPP in TS 23.502, the traffic of a roaming UE 110 can be anchored at the HPLMN 160a. This is known as Home Routed Roaming Support. In this case, HPLMN 160a and VPLMN 160b exchange information to enable the UE 110 to use UP resources from both networks. According to embodiments disclosed herein, the UE 110 with DNR Capability is using the HPLMN 160a and is using the roaming services from a VPLMN 160b. Regarding the nature of the first and second access nodes 120a,b of NR RAT type, it is possible that different types of networks, such as a 5G and a 4G networks, may be involved in the support for the connectivity of the UE 110 with DNR capability.

FIG. 2a shows the case where the two involved access nodes 120a,b are both related to Terrestrial Networks (TN). FIG. 2b shows the scenario where one of the NR RAT types used by the UE 110 is related to a Non-Terrestrial-Network (NTN) where a NR satellite 120b provides the connectivity to the UE 110 and the other NR access node 120a is in a TN. FIG. 2c shows the scenario where both NR access nodes 120a,b, are related to NTNs, i.e., two NR Satellite nodes 120a,b are providing the connectivity to the UE 110 with DNR Capability. Despite the differences in the types of NR satellite, e.g., NR(LEO), NR(MEO), NR(GEO) or NR(OTHERSAT) as defined in TS 23.501, the fundamental principle is that the NR satellite node presents the same N2 and N1 interfaces for the UE 110 and access node interaction with the core network. Therefore, this NR satellite node exchanges the same messages and protocols used by a terrestrial gNB to communicate with the Core Network as well as enable the UE 110 and Core Network exchange of control messages.

Thus, herein the term access node with (or of) NR RAT type is to be understood as any access node that has the capability to exchange N2 and N1 messages with the UE 110 and/or Core Network. In other words, an access node of NR RAT Type is able to exchange the Access Network messages, such as registration request or PDU session request (e.g., as defined in the procedures of 3GPP TS 23.502). Based on this definition of an access node of NR RAT Type, any of the following types of access nodes are considered as access nodes with the same NR RAT type herein: gNB access node, which means a terrestrial access node with NR RAT type; an NR satellite access node with NR(LEO) RAT Type; an NR satellite access node with NR(MEO) RAT Type; an NR satellite access node with NR(GEO) RAT Type; an NR satellite access node with NR(OTHERSAT) RAT Type.

As will be appreciated, if the UE 110 is related to a gNB 120a via HPLMN 160a and a NR satellite access 120b (e.g., with any of the NR satellite RAT types), this is equivalent to the case that the UE 110 is related to 2 access nodes of the same NR RAT type, wherein one access node of the NR RAT type belongs to one PLMN and the second access node of the NR RAT type belongs to a different PLMN.

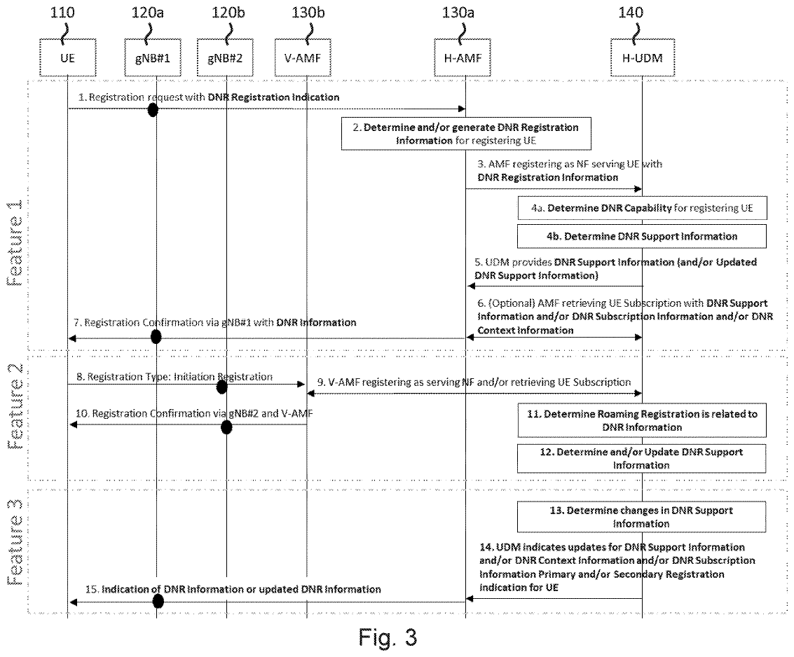

FIG. 3 is a signalling diagram illustrating interactions between the UE 110 of FIG. 1, entities of the HPLMN 160a, in particular the H-UDM 140, the H-AMF 130a, and the first access node 120a, as well as entities of the VPLMN 160b, in particular the V-AMF 130b and the second access node 120b, according to an embodiment for providing dual radio support to the UE 110.

As will be appreciated from the following, steps 5 to 14 of FIG. 3 involving the H-UDM 140 are interactions that H-UDM 140 has with other entities of the system, or tasks performed by the H-UDM 140 where one or more of them may enable (e.g., trigger and/or allow, and/or restrict and/or support) the configuration of and/or define the configuration for the use of the DNR Capability associated with the UE 110.

Step 1 of FIG. 3: The UE 110 is configured to determine if it has the DNR Capability, as well as, to indicate to the HPLMN 160a its DNR Capability, or in other terms its capability to operate with DNR Support.

Step 2 of FIG. 3: The H-AMF 130a is configured to obtain from the UE 110 a DNR Registration Indication and further configured, based on this obtained information and/or based on local configurations, to perform the necessary processing steps for determining and/or generating the DNR Registration Information. The purpose of this information is to indicate to the H-UDM 140 that a UE registration with support for DNR Capability is under consideration.

Step 3 of FIG. 3: The H-AMF 130a provides to the H-UDM 140 the DNR Registration Information.

Based on the obtained DNR Registration Information, the H-UDM 140 executes one or more of the following steps 4a and 4b.

Step 4a of FIG. 3: The H-UDM 140 determines whether the DNR Capability is available for the UE 110 indicated by the H-AMF 130a (i.e., the UE 110 that is registering in the mobile network). In an embodiment, the H-UDM 140 may determine if the DNR Capability is available to the UE 110 by analyzing the DNR Subscription Information associated with the UE 110. The DNR Subscription Information may be directly available at the H-UDM 140 or the H-UDM 140 may interact with one or more other NFs (e.g., the H-UDR 170 illustrated in FIG. 1) in order to request and retrieve the DNR Subscription Information for the UE 110. More detailed embodiments will be described further below.

Step 4b of FIG. 3: The H-UDM 140 determines the DNR Support Information to be provided (and/or updated) related to the UE 110 with DNR Capability. The H-UDM 140 may be configured to provide this information to the H-AMF 130a.

Step 5 of FIG. 3: If the DNR Capability is supported and/or allowed and/or available to the UE 110, the H-UDM 140 may provide to the H-AMF 130a the DNR Support Information and/or updated DNR Support Information and/or the DNR Context Information.

Step 6 of FIG. 3: In case the H-AMF 130a does not have the UE subscription information available, the H-AMF 130a may request the UE subscription information from the H-UDM 140. The H-UDM 140 may include in the UE subscription information the DNR Support Information (which may comprise the DNR Subscription Information) or the DNR Subscription Information. According to embodiments disclosed herein, the DNR Support Information and the DNR Subscription Information may share the same information (and/or parameters) or partially share some information (and/or parameters). This applies also to the DNR Support Information and the DNR Context Information. Thus, according to embodiments disclosed herein, the DNR Support Information may comprise the same or partial information as the DNR Context Information. According to embodiments disclosed herein the H-UDM 140 may store the DNR Subscription Information and the DNR Context Information without explicitly relating these two data sets to the DNR Support Information.

Step 7 of FIG. 3: Based on the DNR Support Information and/or the DNR Context Information and/or DNR Subscription Information received from the H-UDM 140, the H-AMF 130a is configured to determine and/or provide to the UE 110 the DNR Information (which optionally may be included as part of the UE registration response message). The DNR Information enables the UE 110 to become aware of its available and/or activated DNR Capability.

For setting up a secondary DNR Registration the following steps 8 to 12 of FIG. 3 may be executed according to an embodiment.

Step 8 of FIG. 3: The UE 110 with DNR capability determines and selects the VPLMN 160b to connect to via the other NR node, i.e. base station 120b. As will be appreciated, in comparison with a convention mobile network the modifications described here only affect the UE 110. Once the UE 110 has selected the VPLMN 160b to register, no changes are proposed for the actual messages the UE 110 sends for the UE registration via the VPLMN 160b with the NR node RAT Type. As will be appreciated, this limits the required changes in the VPLMN 160b, on roaming interfaces and agreements to a bare minimum. The UE 110 is configured to send the UE registration request to the AMF 130b of the VPLMN 160b, i.e., the V-AMF 130b.

Step 9 of FIG. 3: The V-AMF 130b determines that the registration request is related to a roaming UE 110 and identifies the proper H-UDM 140 of the HPLMN 160a. The V-AMF 130b performs the steps of the registration procedure and interacts during these steps with the H-UDM 140 in order to register as the serving AMF for the roaming UE 110, as well as, to retrieve the subscription information associated with the roaming UE 110.

Step 10 of FIG. 3: Once the V-AMF 130b retrieves the necessary information from the H-UDM 140, and the registration process of the roaming UE 110 is accepted by the VPLMN 160b, the V-AMF 130b sends the registration response to the roaming UE 110.

Step 11 of FIG. 3: When the H-UDM 140 receives a request from the V-AMF 130b for registering as the serving AMF for a roaming user with DNR capacity two situations can exist. If on the one hand the UE 110 has previously registered in the HPLMN 160a and the DNR Capability for the UE 110 in the PLMN with the NR RAT Type is activated, the H-UDM 140 may identify this registration via the V-AMF 130b, i.e., the roaming registration for the UE 110 with the NR RAT Type, as the secondary registration for the UE 110 with the NR RAT type. If on the other hand the roaming registration for the UE 110, i.e., the registration process via the V-AMF 130b, is the first time that the H-UDM 140 is involved in a registration process for the UE 110 with the NR RAT Type, then the H-UDM 140 may determine that the roaming UE 110 is already registered and has the DNR Capability. This enables the H-UDM 140 to properly correlate any future registration process of the UE 110 with the HPLMN 160a via the H-AMF 130a.

As will be appreciated, steps 9 and 11 of FIG. 3 may happen sequentially or substantially in parallel. In the case of a sequential execution of steps 9 and 11, before the H-UDM 140 provides the registration related information to the V-AMF 130b, the H-UDM 140 may perform step 11 and then send to the V-AMF 130b the information required by the V-AMF 130b for the registration of the roaming UE 110 in the VPLMN 160b. As used herein, the following expressions refer to the same entities and/or processes: processing steps related to a UE registration; an AMF (H-AMF 130a or V-AMF 130b) registering at the H-UDM 130 as serving NF for the UE; and UE registration.

Step 12 of FIG. 3: The H-UDM 140a is configured to determine and/or create and/or update the DNR Support Information related to the UE 110. If for the UE 110 there is already DNR Support Information available (e.g., if the UE 110 has registered initially with the H-PLMN), the H-UDM 140 updates the existing DNR Support Information to include the updates related to changes in the DNR Context Information, as a result of the registration of the UE 110 in the other access node of RAT Type (e.g., the second registration in the VPLMN 160b as per the steps shown in FIG. 3, or if the second registration is happening in the HPLMN 160a, which is not illustrated in FIG. 3 but described in more detail further below).

For updating the primary registration and the secondary registration the following steps 13 to 15 of FIG. 3 may be executed according to an embodiment.

Step 13 of FIG. 3: The H-UDM 140 is configured to detect changes of the DNR Support Information. Changes that may be detected by the H-UDM 140 are, for instance, any one of the following changes (although this list is not exhaustive): a) the DNR Subscription Information related to the UE 110 has changed (e.g., a new VPLMN is included or removed as allowed to be used by the UE 110 with DNR Capability); b) the UE 110 is registered in one PLMN with one access node of NR RAT Type and the same UE 110 completed the registration (with the same subscription information) in another PLMN with the other access node of NR RAT Type; c) the UE 110 de-registers from one of the PLMNs associated with the registrations of the UE 100 with the two access nodes 120a,b of NR RAT Type (also referred to herein as dual registration or dual NR registration).

Step 14 of FIG. 3: When the H-UDM 140 detects changes in the DNR Support Information and the H-AMF 130a is registered as serving the UE 110, the H-UDM 140 provides to the H-AMF 130a the updated DNR Support Information or the DNR Context Information associated with the changed DNR Support Information for the UE 110.

Step 15 of FIG. 3: Based on the updated DNR Support Information and/or the DNR Context Information received from the H-UDM 140, the H-AMF 130a is configured to determine and/or provide to the UE 110 with DNR Capability updated DNR Information.

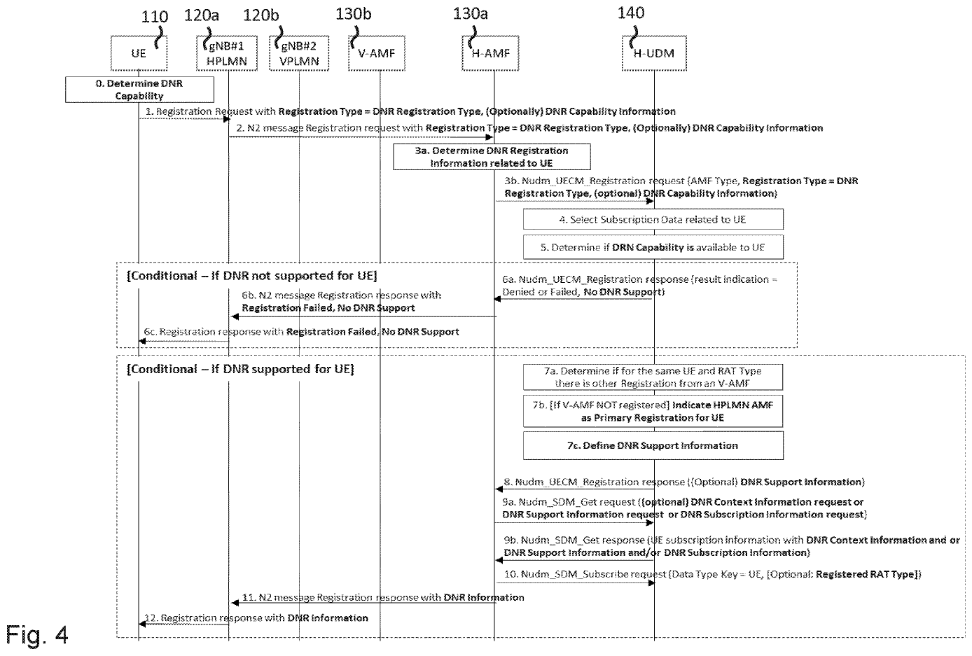

More details of the embodiment shown in FIG. 3 will be described in the following in the context of FIGS. 4 to 8. As will be appreciated, these embodiments are based on the 5G network architecture defined by 3GPP and documented in TS 23.501. The embodiments relate to the extensions for the AMF, UDM, UE, defined mainly in the 3GPP TS 23.501 and TS 23.502 specifications.

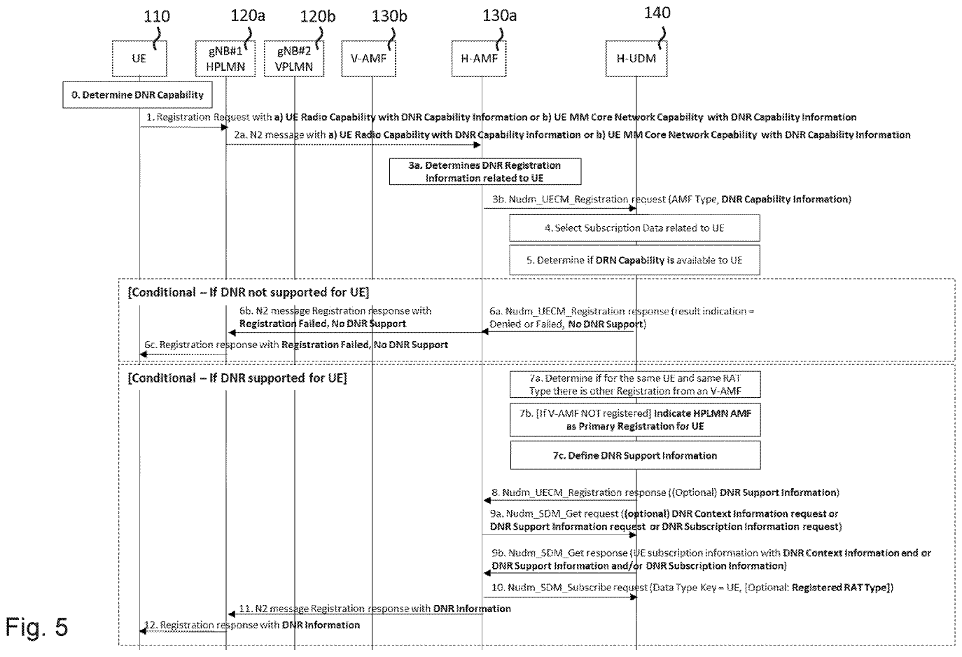

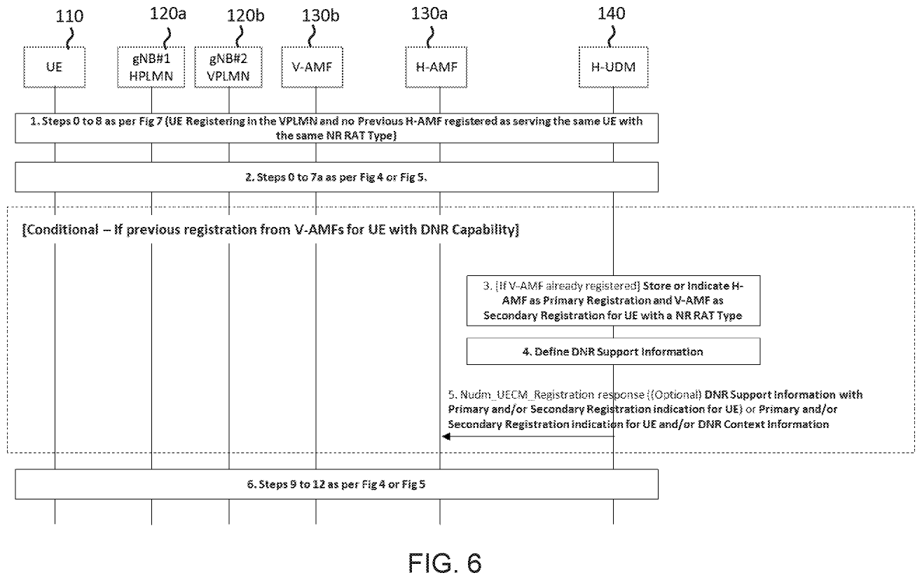

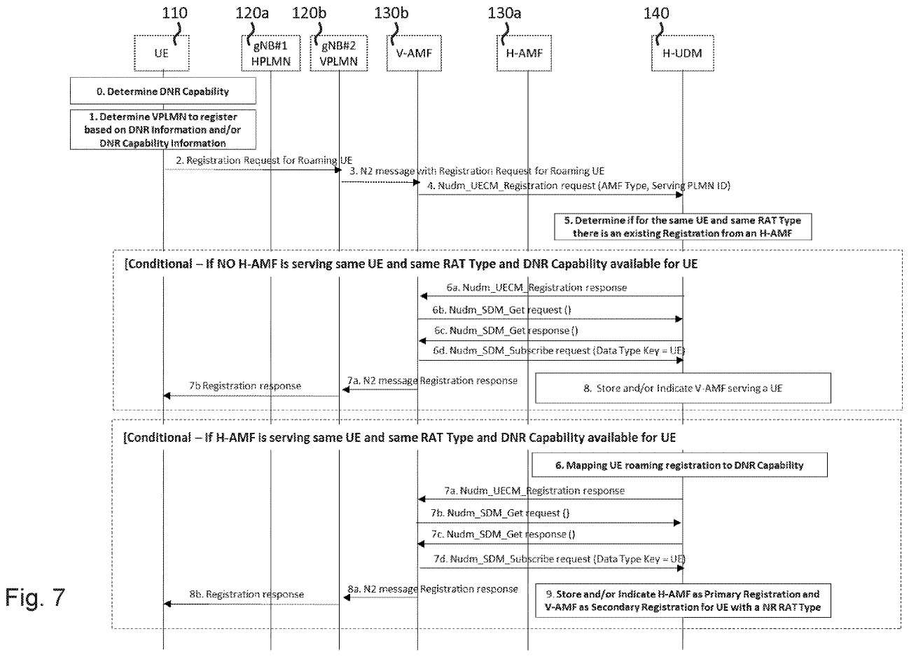

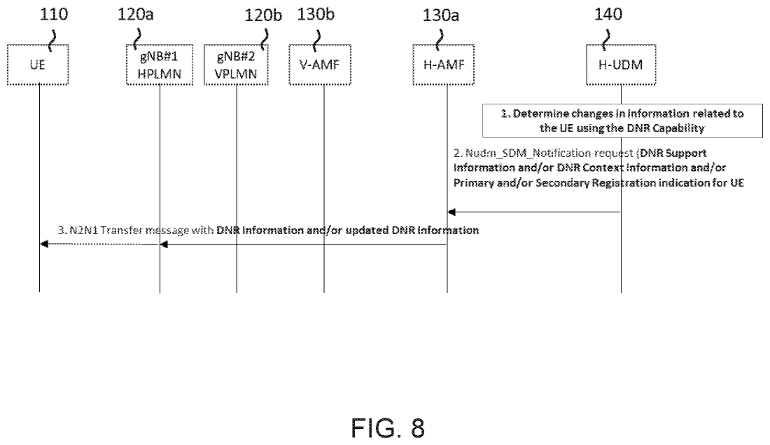

At least two alternatives of possible embodiments for the DNR Registration Indication and the consequences for the DNR Registration Information are described for the first stage of FIG. 3 for enabling DNR Support for dual NR Registrations at the HPLMN 160a. According to a first alternative (Alternative A—shown in FIG. 4), the DNR Registration Indication comprises a new type of registration and/or the DNR Capability Information, while according to a second alternative (Alternative B—shown in FIG. 5) the DNR Registration Information comprises only the DNR Capability Information. The differences on these alternative embodiments lead also to differences in the embodiments of the DNR Registration Information and how such information is determined. Additionally, it is possible that the UE 110 performs the dual registration in any order, i.e., it can first register at the HPLMN 160a and then at the VPLMN 160b or it first registers at the VPLMN 160b and thereafter at the HPLMN 160a. The signaling diagrams of FIG. 4 and FIG. 5 show the case where the UE 110 is first registering at the HPLMN 160a. The case where the UE 110 first registers at the VPLMN 160b and then is registering at the HPLMN 160a is illustrated in FIG. 6. Further embodiments of the middle stage of FIG. 3 for setting up the Secondary DNR Registration at the VPLMN 160b are shown in FIG. 7 and of the last stage of FIG. 3 for updating Primary and Secondary Registrations in FIG. 8, respectively. The embodiments disclosed herein aim at preserving and refraining from including any changes in the interactions among entities from the VPLMN 160b and the HPLMN 160a. The goal is to concentrate on the HPLMN side all the changes that are necessary to support dual registration for UEs with DNR Capability.

By way of examples, the signaling diagrams depicted in FIGS. 4 to 8 show two gNBs as the access nodes 120a,b serving the UE 110 in the HPLMN 160a and VPLMN 160b. However, as already described above, the same steps proposed in all the procedures described below are applicable to any one of the following combinations of access nodes 120a,b: two terrestrial gNBs (i.e., access nodes of NR RAT Type); one terrestrial gNB (i.e., access nodes of NR RAT Type) and one non-terrestrial access node (NR Satellite access associated with any of the following: NR(LEO) RAT Type, NR(MEO) RAT Type, NR(GEO) RAT Type, NR(OTHERSAT) RAT Type; two non-terrestrial access nodes, i.e., NR satellite access nodes, where each of the NR satellite access nodes can be associated with any of the following: NR(LEO) RAT Type, NR(MEO) RAT Type, NR(GEO) RAT Type, NR(OTHERSAT) RAT Type.

The embodiments disclosed herein may also apply in the case that the UE 110 has a single radio stack but has the capability to send radio control plane messages (as well as NAS control plane messages) to two different access nodes. It is assumed herein that if the UE 110 is capable of such an operation, it becomes equivalent to consider that a UE with a single radio stack and a UE with a dual radio stack will perform exactly the same steps disclosed herein. Therefore, embodiments disclosed herein apply to both a UE 110 with a single radio stack and a UE 110 with a dual radio stack.

Above and in the following several types of information and information elements are used, which have the following meaning.

As used herein, the DNR Capability Information may include any of the following: Dual NR UE Capable: This information can be implemented as a configuration flag in the UE 110.
Identification of one or more visible and/or reachable VPLMNs
Access type of visible and/or reachable VPLMNs, where for instance examples of possible parameters are any of the following: terrestrial gNB, NR satellite access node with NR(LEO) RAT Type; NR satellite access node with NR(MEO) RAT Type, NR satellite access node with NR(GEO) RAT Type, NR satellite access node with NR(OTHERSAT).
Dual NR radio capability information: define the radio parameters that can be used by the UE 110 with the two radios of the NR RAT type.

As used herein, the DNR Registration Information may comprises any of the following:
UE identification
Dual NR UE Capable
HPLMN identification
Identification of one or more visible and/or reachable VPLMNs by the UE 110
Identification of the access node of NR RAT Type serving the UE 110 in HPLMN 160a
Description and/or identification of the region and/or area and/or location at HPLMN 160a where the UE 110 requested the registration for the HPLMN 160a

As used herein, the DNR Subscription Information may include any of the following:
DNR Capable (information that indicates whether the UE 110 is allowed to use Dual NR Capability).
the list of (the one or more) allowed and/or restricted VPLMNs (e.g., identified by the PLMN ID) that the UE 110 can connect using the DNR capability
the list (or one or more) regions (or spatial area or location) allowed and/or restricted in the HPLMN 160a and/or in the VPLMN 160b that the UE 110 can use the DNR Capability. Such regions could be identified and/or described in any of the possible formats: cell identification, tracking area identification, street description, geo-coordinates, latitude and longitude coordinates.
List of allowed and/or restricted access types of NR RAT Type associated with the DNR Capability, optionally the list of allowed and/or restricted access types can be further associated with the HPLMN 160a and/or VPLMN 160b identifications.
Examples of parameters (or combinations or values) are any of the following:
Two terrestrial nodes or gNBs (i.e., access nodes of NR RAT Type)
(List of if applicable) One terrestrial access node, e.g., gNB (i.e., access nodes of NR RAT Type) and one non-terrestrial access node (NR Satellite access associated with any of the following: NR(LEO) RAT Type, NR(MEO) RAT Type, NR(GEO) RAT Type, NR(OTHERSAT) RAT Type.
(List of if applicable) Two non-terrestrial access nodes, i.e., NR satellite access nodes, where each of the NR satellite access nodes can be associated with any of the following: NR(LEO) RAT Type, NR(MEO) RAT Type, NR(GEO) RAT Type, NR(OTHERSAT) RAT Type.

As used herein, the DNR Context Information may comprise any of the following:
UE identification (e.g., SUPI)
VPLMN identification (e.g., PLMN ID of VPLMN 160b) associated with one NR node serving UE 110
HPLMN identification (e.g., PLMN ID of HPLMN 160a) associated with one NR node serving UE 110
V-AMF information (e.g., NF ID and/or service information and/or NF address and/or NF service endpoint information) associated with one NR node serving UE 110
H-AMF information (e.g., NF ID and/or service information and/or NF address and/or NF service endpoint information) associated with one NR node serving UE 110
Identification of the access node 120b of NR RAT Type serving the UE 110 in VPLMN 160b
Identification of the access node 120a of NR RAT Type serving the UE 110 in HPLMN 160a
Description and/or identification of the region and/or area and/or location where the UE 110 is able to use DNR Capability
Primary registration information, which may be comprised of any of the following:
   Identification and/or definition of a primary registration (e.g., a flag indicating primary registration)
   HPLMN identification (e.g., PLMN ID of HPLMN 160a) associated with one NR node 120a serving UE 110
   H-AMF information (e.g., NF ID and/or service information and/or NF address and/or NF service endpoint information) associated with one NR node serving UE
   Identification of the access node 120a of NR RAT Type serving the UE 110 in HPLMN 160a
   Identification of type of access node (e.g., terrestrial or non-terrestrial) in HPLMN 160a
   Identification of non-terrestrial access node NR RAT Type in HPLMN 160a (e.g., NR(LEO) RAT Type, NR(MEO) RAT Type, NR(GEO) RAT Type, NR(OTHERSAT) RAT Type)
   Description and/or identification of the region and/or area and/or location where the UE 110 is able to use DNR Capability.
Secondary registration information, which may be comprised of any of the following:
   Identification and/or definition of a secondary registration (e.g., a flag indicating secondary registration)
   VPLMN identification (e.g., PLMN ID of VPLMN 160b) associated with one NR node 120b serving UE 110
   V-AMF information (e.g., NF ID and/or service information and/or NF address and/or NF service endpoint information) associated with one NR node serving UE 110
   Identification of type of access node (e.g., terrestrial or non-terrestrial) in VPLMN 160b
   Identification of non-terrestrial access node NR RAT Type in VPLMN (e.g., NR(LEO) RAT Type, NR(MEO) RAT Type, NR(GEO) RAT Type, NR(OTHERSAT) RAT Type)
   Identification of the access node of NR RAT Type serving the UE in VPLMN 160b

As used herein, the DNR Information may comprise any of the following:
The list of (the one or more) allowed and/or available and/or restricted VPLMNs (e.g., identified by the PLMN ID) that the UE 110 can connect using the DNR capability.
List (or one or more) regions (or spatial area or location) allowed and/or restricted in the HPLMN 160a and/or in the VPLMN 160b that the UE 110 can use the DNR Capability. Such regions could be identified and/or described in any of the possible formats: cell identification, tracking area identification, street description, geo-coordinates, latitude and longitude coordinates.
List of candidate and/or selectable and/or eligible VPLMNs for DNR Capability use:
This information may define a subset of VPLMNs from the allowed list of VPLMNs that can be actually used by the UE 110 with the DNR Capability. In this sense, this indicates the possible selected or candidate VPLMNs.
List of allowed and/or restricted access types of NR RAT Type associated with the DNR Capability. Examples of parameters (or combinations or values) are any of the following:
Two terrestrial nodes or gNBs (i.e., access nodes of NR RAT Type)
(List of if applicable) One terrestrial access node, e.g., gNB (i.e., access nodes of NR RAT Type) and one non-terrestrial access node (NR Satellite access associated with any of the following: NR(LEO) RAT Type, NR(MEO) RAT Type, NR(GEO) RAT Type, NR(OTHERSAT) RAT Type.
(List of if applicable) Two non-terrestrial access nodes, i.e., NR satellite access nodes, where each of the NR satellite access nodes can be associated with any of the following: NR(LEO) RAT Type, NR(MEO) RAT Type, NR(GEO) RAT Type, NR(OTHERSAT) RAT Type.
Primary registration information, which may be comprised of any of the following:
   Identification and/or definition of a primary registration
   HPLMN identification (e.g., PLMN ID of HPLMN) associated with one NR node serving UE
   H-AMF information (e.g., NF ID and/or service information and/or NF address and/or NF service endpoint information) associated with one NR node serving UE
   Identification of the access node of NR RAT Type serving the UE in HPLMN
   Identification of type of access node (e.g., terrestrial or non-terrestrial) in HPLMN
   Identification of non-terrestrial access node NR RAT Type in HPLMN (e.g., NR(LEO) RAT Type, NR(MEO) RAT Type, NR(GEO) RAT Type, NR(OTHERSAT) RAT Type)
   Description and/or identification of the region and/or area and/or location where the UE is able to use DNR Capability.
Secondary registration information, which may be comprised of any of the following:
   Identification and/or definition of a secondary registration
   V-PLMN identification (e.g., PLMN ID of VPLMN) associated with one NR node serving UE
   V-AMF information (e.g., NF ID and/or service information and/or and/or NF address and/or NF service endpoint information) associated with one NR node serving UE
   Identification of the access node of NR RAT Type serving the UE in VPLMN
   Identification of type of access node (e.g., terrestrial or non-terrestrial) in VPLMN
   Identification of non-terrestrial access node NR RAT Type in VPLMN (e.g., NR(LEO) RAT Type, NR(MEO) RAT Type, NR(GEO) RAT Type, NR(OTHERSAT) RAT Type)

According to another embodiment, the primary registration information and/or the secondary registration may be implemented as standalone information, i.e., they are separate sets of information, i.e., they are not part of the DNR Information and/or the DNR Context Information.

FIG. 4 shows a variant of the embodiment of FIG. 3 with a registration process at the HPLMN for the UE 110 with DNR Capability activating and/or requesting activation and/or informing the HPLMN network (e.g., the H-AMF 130a, H-UDM 140) about the intention or indication to use the DNR Capability. In this embodiment, the DNR Registration Indication (mentioned in Step 1 of FIG. 3) is implemented through the definition of a new type of registration. The current 5GS architecture has different types of registration: initial registration and mobility registration. In this embodiment a new type of registration is defined, namely the DNR Registration Type. Based on this new type of registration, the H-AMF 130a can directly determine that the UE registration request is related to the activation or verification or configuration or activation of the support for the UE 110 performing dual registration (or in other words, support the DNR Capability activation for the UE 110). Additionally, the embodiment of the DNR Registration Indication may also include the DNR Capability Information, that indicates information known to (or configured at or installed at) the UE 110 about its DNR Capabilities. The steps for this embodiment are illustrated in FIG. 4.

As will be appreciated, steps 6 to 10 of FIG. 4 involving the H-UDM 140 are interactions that the H-UDM 140 has with other entities of the system, and/or tasks performed by the H-UDM 140, where one or more of them may enable, e.g., trigger and/or support and/or support the configuration and/or define the configuration for and/or manage and/or allow and/or restrict the use of the DNR Capability associated with the UE 110.

Step 0 of FIG. 4: The UE 110 determines if it is configured with the DNR Capability. This means that for instance, in the SIM Card information and/or in the UE chipset, it is defined that the UE may use two NR paths under the same subscription information (e.g. the UE 110 has the DNR Capability), where one path is via the HPLMN 160a and the other path is via an allowed VPLMN 160b. For the UE 110 to be able to use the two NR paths, the UE 110 may need to register in both of the HPLMN 160a and VPLMN 160b. According to an embodiment, it is defined that when the UE 110 is registering with the HPLMN 160a, the UE 110 is configured to check its DNR Capability information and determine if the UE 110 should include in the registration request message any DNR Capability related information.

Step 1 of FIG. 4: If the UE 110 determined, e.g., identified, that it has the DNR Capability, the UE 110 includes the DNR Registration Indication in the UE registration message to be sent to H-AMF 130a, namely via the access node 120a with NR RAT Type with the Access Network (AN) message (e.g., the N1 message container). In an embodiment, the DNR Registration Indication may comprise the following information: the Registration Type set to DNR Registration Type and optionally the DNR Capability Information which may include any of the following: visible and/or reachable VPLMNs (assuming the UE 110 via its radio stack(s) is capable of detecting the available VPLMNs that it could potentially request to be served, i.e., request the registration); the Dual NR radio capability information.

Step 2 of FIG. 4: The gNB 120a of the HPLMN 160a or the HPLMN access node of NR RAT type (e.g., it could be also a satellite access node that is capable of operating as a terrestrial gNB, e.g., uses the same access network messages to interact with the 5G core network) receives the registration request from the UE 110, selects a H-AMF 130a, and sends the registration request with the DRN Registration indication (e.g., the DNR Registration Type and optionally the DNR Capability Information) encapsulated in a N2 message container to the selected H-AMF 130a.

Step 3a of FIG. 4: The H-AMF 130a, based on the received UE registration request from the UE 110, verifies whether such registration request comprises a DNR Registration Indication for the UE 110. For instance, the H-AMF 130a may check the type of registration. If the type of registration is the DNR Registration Type described above, the H-AMF 130a determines that DNR Registration Information needs to be defined and/or created and/or configured, and that such DNR Registration Information is related to the registration process of the UE 110 associated with the received registration request. The H-AMF 130a stores the association of the UE identification (e.g., SUPI) with the information received in the DNR Registration Indication. For instance, this association may be stored together with the UE context at the H-AMF 130a. According to this further embodiment, the DNR Registration Information is equivalent to the combination of (or association of or comprises) the DNR Registration Type and optionally the DNR Capability information. The H-AMF 130a may extend the initial DNR Capability Information received from the UE 110 with any of the following extra fields: HPLMN identification, identification of the access node 120a of NR RAT Type serving the UE 110 in the HPLMN 160a, description and/or identification of the region and/or area and/or location of the HPLMN 160a where the UE 110 requested the registration for the HPLMN 160a. This extended information may be already part of the UE registration request and/or may be based on H-AMF configurations (e.g., the H-AMF 130a may use the cell ID from the UE 110 indicated in the registration message in order to derive the area and/or location in terms of geocoordinates or any other localization format based on its internal mapping configurations of cell ID and localization information).

Step 3b of FIG. 4: During the registration process executed by the AMF 130a (as per the standardized 3GPP TS 23.502 procedure described in Clause 4.2.2.2.2) one of the steps relates to the interaction of the AMF 130a with the UDM 140 in order to register itself as the network function, NF, serving the UE 110 for a given access node of a RAT Type in a given PLMN. The AMF 130a performs this interaction by invoking from the UDM 140 the service Nudm_UECM_Registration request. According to an embodiment, this conventional UDM service is extended in order to enable the H-AMF 130a to provide to the H-UDM 140 that a UE registration has been requested for the UE 110 and this registration process includes the verification and/or activation of DNR Capability for the UE 110. In other words, according to embodiments disclosed herein the conventional Nudm_UECM_Registration request is extended with the DNR Registration Information, which may comprise the DNR Registration Type and optionally the DNR Capability information or the extended DNR Capability information.

Step 4 of FIG. 4: Based on the DNR Registration Information received from the H-AMF 130a, the H-UDM 140 is configured to check whether the subscription information for the UE 110 is related to the information received from the H-AMF 130a.

If the subscription information for the UE 110 (e.g., identified by the SUPI) is available at the H-UDM 140, the H-UDM 140 may use the available UE subscription information for further checking if DNR Capability is supported and/or allowed for the UE 110. In this case, according to an embodiment, Access and Mobility Subscription data stored in the H-UDM 140 may comprise the DNR Subscription Information. It is also possible that according to a different embodiment, a standalone data type for DNR Subscription Information is defined in H-UDM UE subscription data types set.

If the subscription information for the UE 110 (e.g., identified by the SUPI) is not available at the H-UDM 140, the H-UDM 140 may interact with the H-UDR 170 in order to retrieve the UE subscription information. To this end, the H-UDM 140 may invoke the Nudr_DM_Query request service operation setting the Data Set Identifier to “Subscription Data”, the Data Subset identifier to “Access and Mobility Subscription data”, and the Data Key to the SUPI of the UE 110 related to the received information from the H-AMF 130a.

When the UE has the DNR Capability and has a UE subscription allowing the DNR Capability, the H-UDR 170 will provide to the H-UDM 140 the Nudr_DM_Query response service operation including the “Access and Mobility Subscription data” extended with the DNR Subscription Information. Therefore, the “Access and Mobility Subscription data” stored at the H-UDM 140 for the UE 110 may further include the DNR Subscription Information for the UE 110.

Step 5 of FIG. 4: Based on the extended “Access and Mobility Subscription data” stored in the H-UDM 140, the H-UDM 140 is capable of verifying and/or determining if DNR Subscription information is available for the UE 110 related to the information received from the H-AMF 130a in the process of the H-AMF 130a registering as the serving NF for the UE 110. The H-UDM 140 compares the DNR Registration Information received from the H-AMF 130a, for instance, with the DNR Subscription Information, which according to an embodiment may be part of the extended “Access and Mobility Subscription data” related to the UE subscription information.

If the registration type is set to “DNR Registration Type” and the DNR Registration Information comprises the UE Capable DNR flag, this is a first indication that the DNR capability may be available for the UE 110. If the DNR Capability Information is also included in the information received from the H-AMF 130a, the H-UDM 140 may further verify whether the information included in the DNR Capability Information matches the parameters (or information) of the DNR Subscription information. For instance, the H-UDM 140 may check if the list of VPLMNs reachable by the UE 110 are included in the list of allowed and/or restricted VPLMNs for the UE 110. According to another embodiment the H-UDM 140 may perform a check of comparing the location information (e.g., area identification or location identification) related to the information received from the H-AMF 130a with the location information allowed and/or restricted for the use of the DNR capability in the HPLMN 160a comprised in the DNR Subscription information. According to another embodiment the H-UDM 140 may check whether the RAT Type of the access node related to the UE 110 is of the NR type.

If the DNR support is not available to and/or allowed for the UE 110 the following steps 6a-c are performed.

Step 6a of FIG. 4: The H-UDM 140 based on the analysis performed in step 5 may determine that the DNR Capability is not available to and/or not allowed for the UE 110 based on the DNR Registration Information received from the H-AMF 130a and/or the DNR Subscription information for the UE 110. By way of example, the DNR Capability may not available to and/or not allowed for the UE 110 in one or more of the following cases: the RAT Type of the access node 120a is not NR; the UE 110 has no DNR Capability defined in the UE subscription information, the area in the HPLMN 160a where the UE 110 is requesting the DNR Capability is not allowed for the UE 110 (e.g., it is restricted); one or more VPLMN identifications listed as visible and/or reachable by the UE 110 (i.e., included in the DNR Capability information) are not allowed to be used for dual registration for the UE 110. Under these circumstances, the H-UDM 140 may send a Nudm_UECM_Registration response to the H-AMF 130a indicating the failure to register the H-AMF 130a as a NF serving the UE 110. In an embodiment, this operation may further include “No DNR Support” information, which may comprise any of the following fields: a flag indicating DNR Support Denied or No DNR Support or No DNR Allowed, as well as a reason for no DNR support (where the reasons mentioned above may be included).

Step 6b of FIG. 4: Based on the rejection from the H-UDM 140 received by the H-AMF 130a, also the H-AMF 130a determines that the UE registration process is to be rejected. Consequently, the H-AMF 130a provides to the UE 110 a registration rejection message that may include the “No DNR Support” information. This information may be enclosed in a N2 container to be sent to the access node 120a where the UE 110 is trying to register.

Step 6c of FIG. 4: The access node 120a sends to the UE 110 the registration request response including the received “No DNR Support” information received from the H-AMF 130a as part of an AN message. This means that the H-AMF 130a informs or provides to the UE 110 the “No DNR Support” information. Based on the “No DNR Support information”, the UE 110 stops the process of registering to the HPLMN 160a requesting the usage of the DNR Capability. For instance, this means that the UE 110 may stop the registration process for the HPLMN 160a and retry the registration via the same access node 120a, but this time without including any DNR Registration Indication in the registration request.

If the H-UDM 140 determined in step 5 of FIG. 4 that the DNR Capability is allowed for and/or available to the UE 110 the following steps of FIG. may be executed according to an embodiment.

Steps 7a-c of FIG. 4: The H-UDM 140 verifies if the UE identification (with the same subscription information) received from the H-AMF 130a is already registered with another AMF from another PLMN for the same access node RAT type, i.e., NR RAT type. In order to perform such task, the H-UDM 140 may check its internal information to check if it has the record of such a mapping. According to another embodiment, the H-UDM 140 may check if for the UE 110 (e.g., identified by the SUPI) there is Access and Mobility Subscription data with a DNR Support Information sub-data (or subfield) available.

If the H-UDM 140 determines that there exists another V-AMF serving the UE 110 with the same NR RAT Type, the steps 9 to 11 of FIG. 4 are executed.

If the H-UDM 140 determines that no V-AMF is serving the UE 120 with the same NR RAT Type (i.e., there is a single subscription associated with the UE 110 in relationship to the VPLMN 160b and HPLMN 160a), the H-UDM 140 determines or generates the DNR Support information for the UE 110. Furthermore, the H-UDM 140 identifies or signals or indicates the primary registration information associated with the HPLMN 160a. This information may, for instance, be enclosed in the DNR Context Information.

According to an embodiment, the H-UDM 140 may determine and/or generate the DNR Support Information for the UE 110 as part of, i.e. as an extension of the Access and Mobility Subscription data. The DNR Support Information may further include the DNR Context information. The H-UDM 140 may also include the DNR Subscription information in the DNR Support information. In doing so, the information associated with the allowed and/or available DNR Capabilities for the UE 110 as well as the actual DNR capabilities that are being used by the UE 110 are enclosed in a single entry point.

In another embodiment, the H-UDM 140 may determine, generate and/or indicate the DNR Support Information without creating a subfield for this information within the Access and Mobility Subscription data. It is possible that the H-UDM 140 directly stores the DNR Context Information and/or the DNR Subscription Information, which when combined represent the DNR Support information, as part of the Access and Mobility Subscription data.

In another embodiment, the H-UDM 140 may determine, generate and/or indicate the DNR Support Information as a new UE Subscription data type, for instance, being a dataset type in the same level of equivalence of the Access and Mobility Subscription Information or the Session Management Subscription Information (as detailed in the 3GPP standard specification TS 23.502).

Step 8 of FIG. 4: The H-UDM 140 sends the Nudm_UECM_Registration response to the H-AMF 130a for accepting the H-AMF 130a as the serving NF for the UE 110 with the access node 120a of NR RAT type. Optionally, the parameters of the Nudm_UECM_Registration response may include further information to enable the H-UDM 140 to provide also the DNR Support Information.

Steps 9a and 9b of FIG. 4: If the H-AMF 130a does not have available subscription information related to the registering UE 110 (and did not obtain the DNR Support Information in step 8 of FIG. 4), the H-AMF 130a may invoke from the H-UDM 140 the Nudm_SDM_Get service operation request. Optionally, the H-AMF 130a may include in the request any one of the following: DNR Context Information request, DNR Support Information request, DNR Subscription Information request. The H-UDM 140 provides to the H-AMF 140 as part of the Nudm_SDM_Get service operation response the UE Subscription Information including the DNR Support Information, DNR Context Information and/or DNR Subscription Information. Depending on the implementation of the H-UDM 140, the listed information may be part of the Access and Mobility Subscription data or may constitute standalone data types, such as described above in the context of step 7 of FIG. 4.

Step 10 of FIG. 4: The H-AMF 130a may also subscribe to receive changes in the dataset type associated with the DNR Support Information, DNR Context Information and/or DNR Subscription Information. The H-AMF 130a invokes from the H-UDM 140 the Nudm_SDM_Subscribe request service operation. In an embodiment, this service operation may be configured to use a new type of filter to be applied to the data type, namely the Registered RAT type. This field extension enables the H-UDM 140 to provide notifications to the H-AMF 130a when the registered RAT type associated with a UE, such as the UE 110, changes. This is beneficial to support the H-AMF 130a to detect changes in the dual registrations of the UE 110 with DNR Capability. Further details of such changes are described below in the context of the embodiment shown in FIG. 8.

Step 11 of FIG. 4: Based on the information received from the H-UDM 140 (i.e., the DNR Support Information, DNR Context Information and/or DNR Subscription Information), the H-AMF 130a is configured to determine the DNR Information to be sent to the UE 110 as part of the UE registration request. The DNR information may be encapsulated in a N2 message to be delivered to the serving HPLMN access node 120a, and further provided to the UE 110 via an access node, AN, message.

Step 12 of FIG. 4: The access node 120a receives the N2 message from the H-AMF 130a and forwards the registration response including the DNR information to the UE 110.

FIG. 5 shows by means of a further signaling diagram the interaction within the communication system 100 for an embodiment for the case of HPLMN registration before VPLMN registration. FIG. 5 illustrates another embodiment of the registration process at the HPLMN 160a for the UE 110 with DNR Capability activating and/or requesting activation and/or informing the HPLMN network (e.g., the H-AMF 130a and the H-UDM 140) about the intention or indication to use the DNR Capability. In this embodiment, the DNR Registration Indication is implemented by means of a new UE capability information, namely the DNR Capability Information. This capability may be implemented in any one of the following ways: as a standalone container in the registration request AN message sent by the UE 110; as part of a container (or dataset or fields or segments) of the registration request message, such as the UE Radio Capability extended with, i.e. further including DNR Capability Information or the UE MM Core Network Capability extended with, i.e. further including DNR Capability Information.

As will be appreciated, steps 6 to 10 of FIG. 5 involving the H-UDM 140a are interactions of the H-UDM 140a has with other entities of the system 100, and/or tasks performed by the H-UDM 140a where one or more of them enable, e.g., trigger and/or support and/or support the configuration and/or define the configuration for and/or manage and/or allow and/or restrict the use of the DNR Capability associated with the UE 110.

The embodiment shown in FIG. 5 differs from the embodiment shown in FIG. 4 only with respect to steps 1 to 3. All the other steps, interactions and information are the same as described above for the embodiment of FIG. 4. Therefore, in the following only the steps 1 to 3 of the embodiment shown in FIG. 5 are described in more detail.

Step 1 of FIG. 5: If the UE 110 determined, e.g., identified, that it has DNR Capability, the UE 110 may include the DNR Registration Indication in the UE registration message to be sent to the H-AMF 130a (i.e., via the access node 120a with NR RAT Type via the Access Network (AN) message, e.g., the N1 message container). In this embodiment, the DNR Registration Indication comprises the DNR Capability Information, which may include any of the following elements: a UE DNR Capable flag, visible and/or reachable VPLMNs (assuming the UE 110 via its radio stack(s) is capable of detecting the available VPLMNs that it could potentially request to be served, i.e., request the registration); the Dual NR radio capability information. Following the definitions in 3GPP TS 23.502, the UE 110 may be configured to provide such information to the H-AMF 130a (via the AN message through the access node 120a) based on one of the following options: as a standalone container for the DNR Capability Information in the AN message related to the registration request; as an extension of the UE Radio Capability information (and/or container) including the DNR Capability Information; and/or as UE MM Core Network Capability extended with the DNR Capability Information. Thus, according to embodiments disclosed herein the UE Radio Capability or UE MM Core Network Capability already existing in the registration message are extended, i.e. modified to further include the DNR Registration indication (i.e., DNR Capability Information).

Step 2a of FIG. 5: The gNB 120a of the HPLMN 160a, i.e. the HPLMN access node 120a of NR RAT type (e.g., it could be also a satellite access node that is capable to operate as a terrestrial gNB, e.g., uses the same access network messages to interact with the 5G core network) receives the registration request from the UE 110, selects a H-AMF 130a, and sends the registration request with the DRN Registration Indication (e.g., the DNR Capability Information) encapsulated in a N2 message container to the selected H-AMF 130a.

Step 3a of FIG. 5: The H-AMF 130a based on the received UE registration request from the UE 110, verifies whether such registration request comprises a DNR Registration Indication for the UE 110. In this embodiment, the H-AMF 130a checks either if there is a DNR Capability container, or if the UE Radio Capability information (and/or container) comprises the DNR Capability Information, or if the UE MM Core Network Capability comprises the DNR Capability Information. If the Dual NR UE Capable information is present in the DNR Capability Information (e.g., if implemented as an enumeration or a flag, the inclusion of the flag in the message is an indication that the UE 110 has the DNR Capability, if it is implemented as Boolean, and it the Dual NR UE Capable information is set to true, this means the UE 110 has the DNR Capability), the H-AMF 130a determines that a DNR Registration Information needs to be defined and/or created and/or configured and that such DNR Registration Information is related to the registration process of the UE 110 associated with the received registration request from the UE 110.

The H-AMF 130a stores the association of the UE identification (e.g., SUPI) with the information received in the DNR Registration Indication (i.e., the DNR Capability Information). For instance, this association may be stored together with the UE context at the H-AMF 130a. According to this alternative embodiment, the DNR Registration Information is equivalent to the DNR Capability information. The H-AMF 130a may optionally extend, i.e. augment the initial DNR Capability Information received from the UE 110 with any of the following extra fields: HPLMN identification; identification of the access node 120a of NR RAT Type serving the UE 110 in the HPLMN 160a; description and/or identification of the region and/or area and/or location within the HPLMN 160a, where the UE 110 requested the registration for the HPLMN 160a. This additional, i.e. extended information may be already part of the UE registration request and/or based on H-AMF configurations (e.g., the H-AMF 130a may use the cell ID of the UE 110 indicated in the registration message in order to derive the area and/or location in terms of geocoordinates or any other localization format based on its internal mapping configurations of cell ID to localization information).

Step 3b of FIG. 5: During the registration process executed by the H-AMF 130a (as per 3GPP TS 23.502 procedure described in Clause 4.2.2.2.2) one of the steps relates to the H-AMF 130a interacting with the H-UDM 140 in order to register itself as the NF serving the UE 110 for a given access node of a RAT Type in a given PLMN (also referred as mobile network or network operator or operator or network). The H-AMF 130a performs this interaction by invoking from the H-UDM 140 the service Nudm_UECM_Registration request. In an embodiment, this service provided by the H-UDM 140 is extended in order to enable the H-AMF 130a to inform the H-UDM 140 that a UE registration has been requested by the UE 110 and that this registration process includes the verification and/or activation of DNR Capability for the UE 110. Thus, the Nudm_UECM_Registration request is extended with the DNR Registration Information, that in this embodiment may comprise the DNR Capability Information or the extended DNR Capability information.

Steps 4 to 12 of FIG. of FIG. 5 are identical to steps 4 to 12 of FIG. 4, which have been already described in detail in the context of FIG. 4 above.

FIG. 6 illustrates by means of a further signaling diagram the interaction within the communication system 100 for an embodiment for the case of HPLMN registration after VPLMN registration.

As will be appreciated, stages 3 to 5 of FIG. 6 involving the H-UDM 140 are interactions of the H-UDM 140 with other entities of the system 100, and/or tasks performed by the H-UDM 140 where one or more of them enable, e.g., trigger and/or support and/or support the configuration and/or define the configuration for and/or manage and/or allow and/or restrict the use of the DNR Capability associated with the UE 110.

Stage 1 of FIG. 6: This stage comprises the process of the UE 110 registering in the VPLMN 160b with no previous H-AMF 130a registered as serving the UE 110 with the same NR RAT Type. The details of this process are described in the context of steps 0 to 8 of FIG. 7 below.

Stage 2 of FIG. 6: This stage corresponds to the initial steps 0 to 7a of FIG. 4 and FIG. 5 for the UE 110 registering in the HPLMN 160a including the DNR Registration Indication (step 0 of FIG. 4 and FIG. 5) up to the point that the H-UDM 140 verifies if another V-AMF 130b is registered as serving the UE 110 with another access node 120b with the same NR RAT Type as the one of the registration via the HPLMN 160a (step 7a of FIG. 4 and FIG. 5).

Stage 3 of FIG. 6: When the H-UDM 140 determines that the DNR Capability is allowed for the UE 110 and that a previous V-AMF 130b had already registered as serving the UE 110 with a single registration for an access node 120b with the NR RAT Type, the H-UDM 140 allows the new H-AMF 130a to be also registering as an NF serving the UE 110 for a different access node 120a with the same NR RAT Type. The H-UDM 140 stores and/or keeps an indication that the H-AMF 130a takes the role of primary registration, while the information that the previous registered V-AMF 130b is serving the same UE 110 with the same NR RAT Type is kept in the H-UDM 140 and is now related to a secondary registration for the UE 110 with the same NR RAT Type. This information and/or indications may then be associated to the DNR Support Information.

Stage 4 of FIG. 6: In Case the H-UDM 140 had already defined a DNR Support Information and/or a DNR Context Information for the UE 110 associated with the V-AMF 130b serving the UE 110 in an access node 120b with NR RAT Type, the H-UDM 140 updates the existing DNR Support Information and/or the DNR Context Information including the relevant information associated with the H-AMF registration as serving the UE 110 as well as with the information and/or indications of primary and secondary registrations in the different AMFs from different PLMNs for the same UE 110 with the same NR RAT Type. Furthermore, the same principles for the creation and/or definition of the DNR Support information described for step 7c of FIG. 4 and FIG. 5 also apply to the embodiment shown in FIG. 6.

The stages 5 and 6 of FIG. 6, which are described in more detail in the following, may both be executed or stage 5 may be executed without the mentioned optional information and then stage 6 is executed.

Stage 5 of FIG. 6: The H-UDM 140 sends a Nudm_UECM_Registration response to the H-AMF 130a for accepting the H-AMF 130a as the serving NF for the UE 110 with the access node of NR RAT type. Optionally, the parameters of the Nudm_UECM_Registration response may be extended to enable the H-UDM 140 to provide any of the following as part of the response: DNR Support Information with Primary and/or Secondary Registration indication for the UE 110; Primary and/or Secondary Registration indication for the UE 110; and/or DNR Context Information.

Stage 6 of FIG. 6: The procedure continues following the step 9 to 12 described in in FIG. 4 and FIG. 5.

FIG. 7 shows by means of a further signaling diagram the interaction within the communication system 100 according to a more detailed embodiment for setting up the secondary DNR registration. FIG. 7 illustrates another embodiment, where the UE 110 triggers the registration in the VPLMN 160b using another access node 120b of NR RAT Type. As will be appreciated, no changes are necessary in the roaming interactions and exchanged information. All the changes are limited to the HPLMN 160a in order to implement this embodiment.

As will be appreciated, steps 5 to 9 of FIG. 7 involving the H-UDM 140 are interactions of the H-UDM 140 with other entities of the system 100, and/or tasks performed by the H-UDM 140 where one or more of them enable, e.g., trigger and/or support and/or support the configuration and/or define the configuration for and/or manage and/or allow and/or restrict the use of the DNR Capability associated with the UE 110.

Step 0 of FIG. 7: The UE 110 determines if it is configured with the DNR Capability. This means that for instance, in the SIM Card information and/or in the UE chipset, it is defined that the UE 110 can use two NR paths (e.g., two access nodes of NR RAT Type) using the same subscription information (e.g. the UE 110 has the DNR Capability), where one path is via the HPLMN 160a and the other path is via an allowed VPLMN 160b. According to an embodiment, when the UE 110 is registering at the VPLMN 160b it does not include any information in the registration request that can indicate the DNR capability to the VPLMN entities interacting with the UE 110. Therefore, the DNR capability of the UE 110 is transparent to the VPLMN 160b. Nevertheless, the UE registration request sent by the UE 110 to the VPLMN entities may be based on DNR Capability Information and/or the DNR Information available to the UE 110.

Step 1 of FIG. 7: The UE 110 may use the DNR Capability Information and/or DNR Information received from the H-AMF 130a of the HPLMN 160a in order to determine which reachable VPLMN 160b it should select for triggering the registration request at the VPLMN 160b which may constitute the secondary registration for the UE 110, when the UE 110 completes its dual registration for using the DNR Capability. If the UE 110 has available only the DNR Capability Information, the UE 110 may use the visible and/or reachable VPLMNs identification to select one VPLMN 160b to register. If the DNR Information is available to the UE 110, the UE 110 may use any information from the DNR Information for the VPLMN selection. Examples of relevant information from DNR Information that can be considered in the selection process by the UE 110 are any of the following: a list of (the one or more) allowed and/or restricted VPLMNs; a list (or one or more) regions (or spatial areas or locations) allowed and/or restricted in the HPLMN 160a and/or in the VPLMN 160b, where the UE 110 can use the DNR Capability; a list of allowed and/or restricted access types of NR RAT Type associated with the DNR Capability; a list of candidate and/or selectable and/or eligible VPLMNs for using the DNR Capability. Optionally, the UE 110 may combine the available information in the DNR Information with the DNR Capability Information, in order to select the VPLMN to register. For instance, the UE 110 may select the VPLMN by combining the list of reachable and/or visible VPLMNs information from the DNR Capability Information with the List of candidates and/or selectable VPLMNs comprised in the DNR Information.

Steps 2 to 4 of FIG. 7: These steps may be executed in accordance with the standardized 5GS systems without any extensions or modifications to allow the roaming UE 110 to send a registration request to the VPLMN 160b.

Step 5 of FIG. 7: When the H-UDM 140 receives from the V-AMF 130b the Nudm_UECM_Registration request service invocation, the H-UDM 140 is capable of identifying, i.e. determining the following information and/or parameters: the UE identification; the access node RAT Type; the VPLMN ID; and/or the V-AMF 130b identification. Based on this information, the H-UDM 140 may determine if there exist for the UE 110, with the same RAT Type another AMF 130a but from the HPLMN 160a that is serving the UE 110. This determination may be performed in any one of the following ways. The H-UDM 140 may check if for the UE identification (e.g., SUPI) there is any available DNR Support information and/or DNR Context Information for the UE 110. If this is the case, the H-UDM 140 may check the current AMF serving the UE 110. If it is from the same VPLMN 160b or from another VPLMN, then the H-UDM 140 does not consider the received information from the V-AMF 130b as a UE registration related to DNR Capability, and therefore conventional registration mechanisms may be applied without changes. If, however, the H-UDM 140 identifies that the existing registered AMF serving the UE 110 belongs to the HPLMN 160a, then the H-UDM 140 considers the information received from the V-AMF 130b as related to a UE registration with DNR Capability.

In case no H-AMF 130a is registered as serving the UE 110, the conditional steps 6a to 8 illustrated in the middle portion of FIG. 7 may be executed.

Conditional steps 6a-d of middle portion of FIG. 7: In this case, the H-UDM 140 may interact with the V-AMF 130b in accordance with the standardized procedures defined in TS 23.502 R18. The H-UDM 140 may or may not accept the V-AMF 130b as serving NF for the UE 110 and store the relevant information. If the V-AMF 130b does not have available the subscription information of the UE 110, it may request such information. The H-UDM 140 may provide the UE Subscription information to the VPLMN 160b without exposing any DNR Capability related information. For instance, if according to an embodiment the DNR Subscription Information is comprised in, i.e. part of the “Access and Mobility Subscription data”, the H-UDM 140 may provide a simplified or reduced version of the “Access and Mobility Subscription data” to the V-AMF 130b. In an embodiment, the simplified or reduced version of the “Access and Mobility Subscription data” may be the standardized version of the “Access and Mobility Subscription data” without the DNR Subscription Information.

Conditional steps 7a,b of the middle portion of FIG. 7: The V-AMF 130b receives the information from the H-UDM 140 and proceeds with the UE registration, providing to the UE 110 the acceptance and/or rejection of the UE registration request.

Conditional step 8 of the middle portion of FIG. 7: The H-UDM 140 stores the information of the V-AMF 130b (or updated V-AMF 130b) as serving NF to the UE 110 with the RAT Type.

In the alternative case that the H-AMF 130a is registered as serving the UE 110, the conditional steps 6 to 9 illustrated in the lower portion of FIG. 7 may be executed.

Conditional step 6 of the lower portion of FIG. 7: Based on the determination that the H-AMF 130a is already registered as serving the UE 110 with the same RAT type indicated in the request received from the V-AMF 130b, the H-UDM 140 determines that the message received from the V-AMF 130b is related to the UE 110 with DNR Capability executing a UE registration in the VPLMN 160b. Such a determination may be performed by the H-UDM 140 based on configuration information, wherein the H-UDM 140 is configured to assume that the UE registration of the UE 110 via a VPLMN 160b is considered the secondary registration of the UE 110 with DNR Capability, whenever there exist a record of DNR Support Information and/or DNR Context Information for the UE 110 with the same RAT Type in the HPLMN 160a and the VPLMN 160b is allowed and/or available to the UE 110 with DNR capability.

Conditional steps 7 and 8 of the lower portion of FIG. 7: In this case, the H-UDM 140 performs the same operations as described in the context of the conditional steps 6 and 7 of the middle portion of FIG. 7 (i.e. the case, where no H-AMF is registered as serving the UE 110).

Conditional step 9 of the lower portion of FIG. 7: The H-UDM 140 may perform any one of the following operations, in particular for storing and/or updating the Primary and Secondary registration information.

If there exists DNR Support Information and/or a DNR Context information for the UE 110 with the same RAT Type with the H-AMF 130a as serving NF, the H-UDM 140 may update the DNR Support Information and/or a DNR Context information including the definition of and/or updating the Primary Registration Information and/or the Secondary Registration information related to the dual registration of the UE 110 with the different AMFs and PLMNs for the same RAT TYPE and UE subscription.

If the Primary Registration Information and/or the Secondary Registration information are standalone information (e.g., not comprised in the DNR Support Information and/or a DNR Context information), the H-UDM 140 may update and/or create the Primary Registration Information and/or the Secondary Registration information associated with the dual registration of the UE 110 with the different AMFs 130a,b and PLMNs for the same RAT TYPE and UE subscription.

FIG. 8 shows by means of a further signaling diagram the interaction within the communication system 100 according to a more detailed embodiment for updating the primary and secondary registrations. In this embodiment, the H-UDM 140 is capable of detect changes related to the DNR Support Information associated with a UE 110 with active dual registration (i.e., with activated DNR Capability or using DNR Capability).

As will be appreciated, steps 1 and 2 of FIG. 8 involving the H-UDM 140 are interactions of the H-UDM 140 with other entities of the system, and/or tasks performed by the H-UDM where one or more enable, e.g., trigger and/or support and/or support the configuration and/or define the configuration for and/or manage and/or allow and/or restrict the use of the DNR Capability associated with the UE 110.

Step 1 of FIG. 8: The H-UDM 140 detects changes in information related to the UE 110 using the DNR Capability. Any of the following are examples of changes in information related to the UE 110 using DNR Capability:
The registration of another AMF as a serving NF for the already registered UE 110 with the NR RAT Type. For instance, if the UE 110 first registered with the HPLMN 160a, the change in the DNR Support information and/or DNR Context Information and/or Primary Registration Information and/or Secondary Registration Information is related to adding the information related to the secondary registration, i.e., the V-AMF 130b serving the UE 110 also with the NR RAT Type. On the other hand, if the UE 110 has registered first in the VPLMN 160b, the changes are related to the primary registration of the UE 110 with the HPLMN 160a for the same subscription and the same RAT Type.
A de-registration related to one of the two registrations of the UE 110 associated with the DNR Support Information and/or DNR Context Information and/or Primary Registration Information and/or Secondary Registration Information is detected by the H-UDM 140. In this case, one of the AMFs 130a,b serving the UE 110 for the same subscription and with access nodes 120a,b with the same NR RAT Type sends to the H-UDM 140 a Nudm_UECM_Deregistration request.
The DNR Subscription Information related to the UE changes. In this case, it may be possible that the UDR 170 notifies the H-UDM 140 about changes in the UE subscription information, and the H-UDM 140 is capable of detecting these changes in the DNR Subscription Information. Examples of changes in the DNR Subscription Information are any of the following (but not restricted only to these changes): removal and/or inclusion of allowed and/or restricted VPLMNs; removal and/or inclusion of allowed and/or restricted spatial areas and/or locations in the HPLMN 160a and/or the VPLMN 160b, where the UE 110 may use the DNR capability.

Step 2 of FIG. 8: The H-UDM 140 notifies the H-AMF 130a using the Nudm_SDM_Notification service operation extended with, i.e. further including the DNR Support Information and/or DNR Context Information and/or DNR Subscription Information and/or Primary and/or Secondary Registration indication for the UE 110. As will be appreciated, the H-UDM 140 may provide notifications related to the UE 110 using DNR Capability only to the H-AMF 130a and may mute any notifications for the V-AMF 130b.

Step 3 of FIG. 8: Based on the information received from H-UDM 140 related to changes in information related to the DNR Capability associated with the UE 110, the H-AMF 130a determines if DNR Information should be created and send to the UE 110 or if already existing DNR Information associated with the UE 110 should be updated and sent to the UE 110. For instance, in the first case, if the UE 110 registered first with the VPLMN 160a, the UE 110 did not receive from the H-AMF 130a any DNR Information. Therefore, in that case the H-AMF 130a may define, i.e. generate the DNR Information and send this information to the UE 110 (e.g., using a N2N1 transfer message extended with the DNR Information). This DNR Information allows the UE 110 to become aware that the DNR Capability is activated for the registrations in the HPLMN 160a and the VPLMN 160b. In the second case, i.e. if the UE 110 already received the DNR Information from the H-AMF 130a, the H-AMF 130a may determine that the received information from the H-UDM 140 requires a change and/or update of the DNR Information associated with the UE 110. Any of the following are examples of information received from the H-UDM 140 that may require changes in the DNR Information by the H-AMF 130a: a change in the allowed and/or selectable and/or available VPLMNs; a change in the allowed and/or restricted locations, where the UE 110 may use the DNR Capability in the HPLMN 160a and/or the VPLMN 160b; the de-registration of the secondary registration with the VPLMN 160b by the UE 110, which leads to the halting or stopping of the usage of the DNR capability with the VPLMN 160b.

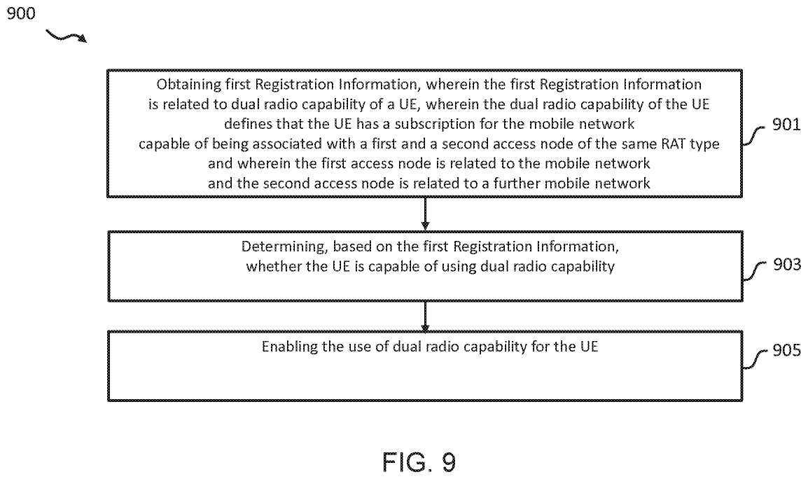

FIG. 9 is a flow diagram illustrating a method 900 for operating a first control plane entity 140, in particular a H-UDM 140, related to UE registration management in a mobile network 160a. The method 900 comprises a step 901 of obtaining first Registration Information, wherein the first Registration Information is related to dual radio capability of the UE 110, wherein the dual radio capability of the UE 110 indicates that the UE 110 has a subscription for the mobile network 160a capable of being associated with a first and a second access node 120a,b of the same RAT type and wherein the first access node 120a is related to the mobile network, e.g. the HPLMN 160a, and the second access node 120b is related to another mobile network, e.g. the VPLMN 160b. The method 900 further comprises a step 903 of determining, based on the first Registration Information, whether the UE 110 is capable of using dual radio capability. The method 900 comprises a further step 905 of enabling the use of dual radio capability for the UE 110.

The method 900 illustrated in FIG. 9 can be performed by the first control plane entity 140, in particular H-UDM 140, according to an embodiment. Thus, further features of the method 900 result directly from the functionality of the first control plane entity 140 as well as the different embodiments thereof described above and below.

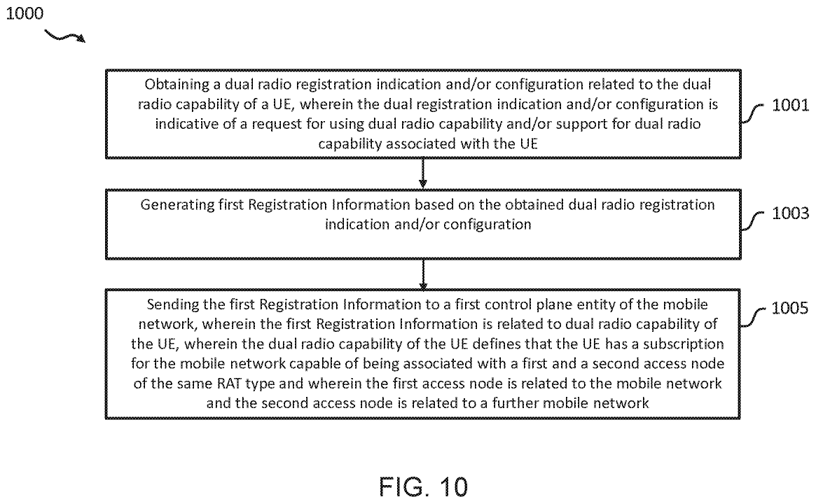

FIG. 10 is a flow diagram illustrating a method 1000 for operating a second control plane entity 130a, in particular a H-AMF 130a, for a mobile network 160a. The method 1000 comprises a step 1001 of obtaining a dual radio registration indication and/or configuration related to the dual radio capability of a UE 110, wherein the dual registration indication and/or configuration is indicative of a request for using dual radio capability and/or support for dual radio capability associated with the UE 110. Moreover, the method 1000 comprises a step 1003 of generating first Registration Information based on the obtained dual radio registration indication and/or configuration. The method 1000 further comprises a step 1005 of sending the first Registration Information to a first control plane entity 140, in particular a H-UDM 140, of the mobile network 160a, wherein the first Registration Information is related to dual radio capability of the UE 110, wherein the dual radio capability of the UE 110 indicates that the UE 110 has a subscription for the mobile network 160a capable of being associated with a first and a second access node 120a,b of the same radio access technology, RAT, type and wherein the first access node 120a is related to the mobile network 160a and the second access node 120b is related to another mobile network, e.g. the VPLMN 160b.

The method 1000 illustrated in FIG. 10 can be performed by the second control plane entity 130a, in particular H-AMF 130a, according to an embodiment. Thus, further features of the method 1000 result directly from the functionality of the second control plane entity 130a as well as the different embodiments thereof described above and below.

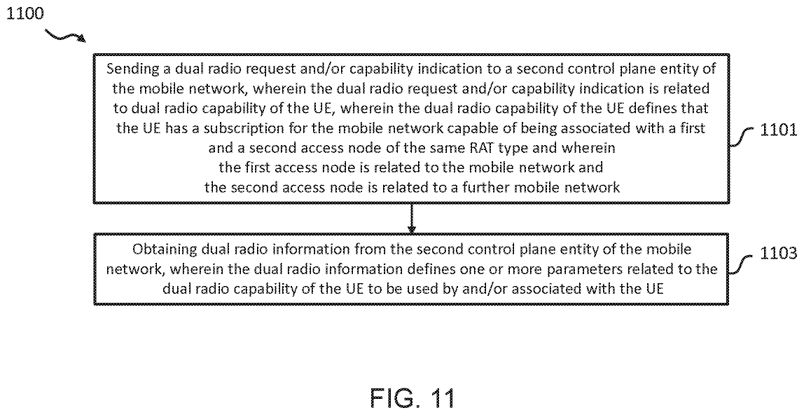

FIG. 11 is a flow diagram illustrating a method 1100 for operating the UE 110 for using dual radio capability in a mobile network 160a. The method 1100 comprises a step 1101 of sending a dual radio request and/or capability indication to a second control plane entity 130a, in particular H-AMF 130a, of the mobile network 160a, wherein the dual radio request and/or capability indication is related to dual radio capability of the UE 110, wherein the dual radio capability of the UE 110 indicates that the UE 110 has a subscription for the mobile network 160a capable of being associated with a first and a second access node 120a,b of the same radio access technology, RAT, type and wherein the first access node 120a is related to the mobile network, e.g HPLMN 160a, and the second access node 120b is related to another mobile network, e.g. VPLMN 160b. Moreover, the method 1100 comprises a step 1103 of obtaining dual radio information from the second control plane entity 130a, in particular H-AMF 130a, of the mobile network 160a, wherein the dual radio information indicates one or more parameters related to the dual radio capability of the UE 110 to be used by and/or associated with the UE 110.

The method 1100 illustrated in FIG. 11 can be performed by the UE 110 according to an embodiment. Thus, further features of the method 1100 result directly from the functionality of the UE 110 as well as the different embodiments thereof described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit.

What is claimed is:

1. A first control plane entity related to user equipment (UE) registration management in a mobile network, wherein the first control plane entity is implemented by a processor and is configured to:
obtain first Registration Information, wherein the first Registration Information is related to dual radio capability of the UE, the dual radio capability of the UE indicates that the UE has a subscription for the mobile network capable of being associated with a first and a second access node of the same radio access technology (RAT) type and wherein the first access node is related to the mobile network and the second access node is related to another mobile network;
determine, based on the first Registration Information, whether the UE is capable of using dual radio capability; and
enable use of dual radio capability for the UE.

2. The first control plane entity of claim 1, wherein the first Registration Information is indicative of a request for using at least one of dual radio capability or support for dual radio capability, and
the first control plane entity is configured to obtain the first Registration Information from a second control plane entity, or
the first Registration Information is a local configuration.

3. The first control plane entity of claim 1, wherein at least one of the following is met:
the first Registration Information comprises a dual radio registration type, wherein the dual radio registration type indicates a type of UE registration request, or
the first Registration Information comprises dual radio Capability Information, wherein the dual radio Capability Information indicates at least one of one or more parameters or one or more configurations related to the dual radio capability of the UE.

4. The first control plane entity of claim 3, wherein the dual radio Capability Information comprises any of the following:
an indication that the UE has dual radio capability;
identification of one or more other mobile networks visible or reachable by the UE;
access types of the one or more other mobile networks visible or reachable by the UE;
one or more radio parameters usable by the UE with the first and the second access node of the same RAT type.

5. The first control plane entity of claim 1, wherein the first control plane entity is further configured to determine whether the UE is capable of using dual radio capability based on at least one of: dual radio Subscription Information or one or more local configurations related to the dual radio capability for the UE or for the mobile network, wherein the dual radio Subscription Information indicates at least one of one or more supported, allowed or restricted parameters related to the dual radio capability for the UE.

6. The first control plane entity of claim 5, wherein the first control plane entity is further configured to determine the at least one of the one or more supported, allowed or restricted parameters related to the dual radio capability for the UE.

7. The first control plane entity of claim 5, wherein the dual radio Subscription Information comprises one or more of the following:
an indication that the UE is allowed to use or has the dual radio capability;
identification of one or more other mobile networks allowed to be used by the UE with dual radio capability;
identification of one or more other mobile networks restricted to be used by the UE with dual radio capability;
information about one or more regions, spatial areas or locations covered by at least one of the mobile network or the other mobile network, where the UE is allowed to use dual radio capability; or
information about one or more radio access types the UE is allowed to use with dual radio capability.

8. The first control plane entity of claim 5, wherein the first control plane entity is configured to perform at least one of the following:
obtain the dual radio Subscription Information from a local storage, or
receive the dual radio Subscription Information from another control plane entity of the mobile network.

9. The first control plane entity of claim 1, wherein to enable the use of the dual radio capability for the UE the first control plane entity is further configured to perform at least one of the following:
store an indication that the UE has the dual radio capability;
store at least one of one or more supported, allowed, or restricted parameters related to the dual radio capability for the UE;
allow a second control plane entity from the mobile network to register as serving the UE with the first access node and allow another control plane entity from the other mobile network to register as serving the UE with the second access node;
maintain an indication of the second control plane entity from the mobile network as serving the UE with the first access node when receiving a request from the other control plane entity of the other mobile network to register as serving the UE with the second access node; or
maintain an indication of the other control plane entity from the other mobile network as serving the UE with the second access node when receiving a request from the second control plane entity of the mobile network to register as serving the UE with the first access node.

10. A second control plane entity for a mobile network, wherein the second control plane entity is implemented by a processor and is configured to:
obtain at least one of a dual radio registration indication or a configuration related to a dual radio capability of a user equipment (UE), wherein the at least one of the dual radio registration indication or the configuration is indicative of at least one of a request for using dual radio capability or support for dual radio capability associated with the UE, the dual radio capability of the UE indicates that the UE has a subscription for the mobile network capable of being associated with a first and a second access node of the same radio access technology (RAT) type, the first access node is related to the mobile network, and the second access node is related to another mobile network;
generate first Registration Information based on the obtained at least one of the dual radio registration indication or the configuration; and
provide the first Registration Information to a first control plane entity of the mobile network, wherein the first Registration Information is related to the dual radio capability of the UE.

11. The second control plane entity of claim 10, wherein the second control plane entity is configured to generate the first Registration Information, in response to receiving a request from the UE comprising the dual radio registration indication.

12. The second control plane entity of claim 10, wherein the second control plane entity is further configured to obtain from the first control plane entity at least one of:
dual radio Support Information or updated dual radio Support Information, wherein the dual radio Support Information indicates at least one of: dual radio Capability Information that can be supported by or configured for the UE, or dual radio Capability Information that is in use by the UE or that is associated with the UE at a given point in time;
dual radio Subscription Information, wherein the dual radio Subscription Information indicates at least one of one or more supported, allowed or restricted parameters related to the dual radio capability of the UE;
dual radio Context Information related to the UE with dual radio capability, wherein the dual radio Context Information related to the UE indicates the information related to the dual radio capability in use by the UE or associated to the UE at a given point in time;
primary registration information associated with the UE, wherein the primary registration information comprises one or more parameters related to the UE with dual radio capability for the mobile network;
secondary registration information associated with the UE, wherein the secondary registration information comprises one or more parameters related to the UE with dual radio capability for the other mobile network.

13. The second control plane entity of claim 10, wherein the second control plane entity is further configured to perform at least one of the following:
provide dual radio information to the UE, or
provide updated dual radio information to the UE,
wherein the dual radio information or the updated dual radio information is based on obtained information from the first control plane entity, and wherein the dual radio information indicates one or more parameters related to the dual radio capability of the UE to be used by or associated with the UE.

14. A user equipment (UE) for using dual radio capability in a mobile network, wherein the UE comprises a processor configured to execute instructions to cause the UE to:
provide a dual radio registration indication to a second control plane entity of the mobile network, wherein the dual radio registration indication is related to dual radio capability of the UE, wherein the dual radio capability of the UE indicates that the UE has a subscription for the mobile network capable of being associated with a first and a second access node of the same radio access technology (RAT) type and wherein the first access node is related to the mobile network and the second access node is related to another mobile network; and
obtain from the second control plane entity of the mobile network dual radio information, wherein the dual radio information indicates one or more parameters related to the dual radio capability of the UE to be used by or associated with the UE.

15. The UE of claim 14, wherein the dual radio registration indication comprises a dual radio registration type, wherein the dual radio registration type indicates at least one of a type of UE registration request or dual radio Capability Information, wherein the dual radio Capability Information indicates one or more parameters or one or more configurations related to the dual radio capability of the UE.

16. The UE of claim 15, wherein the UE is configured to obtain the dual radio Capability Information based on at least one of stored configuration information or monitored information.

17. The UE of claim 14, wherein, in response to providing via a message the dual radio registration indication to the second control plane entity, the UE is configured to receive from the second control plane entity a confirmation of the registration comprising the dual radio information.

18. The UE of claim 14, wherein, based on the obtained dual radio Information, the UE is further configured to select the other mobile network for registering when using the dual radio capability.

19. The UE of claim 14, wherein, in response to providing the dual radio registration indication to the second control plane entity, the UE is configured to receive from the second control plane entity a registration rejection with a dual radio rejection indication related to the dual radio capability.

20. The UE of claim 19, wherein the dual radio rejection indication comprises at least one of the following:
indication that dual radio capability is not available or allowed for the UE,
one or more parameters comprised in the dual radio Registration Indication, or
indication that registration is not supported or allowed for the UE.
